(19) United States
(12) Patent Application Publication
(10) Pub. No.: US 2026/0162973 A1
(43) Pub. Date: Jun. 11, 2026

(54) CATHODE MATERIALS HAVING LITHIUM PHOSPHATE SURFACE SPECIES

(71) Applicant: QuantumScape Battery, Inc., San Jose, CA (US)

(72) Inventors: Cheng-Chieh CHAO, San Jose, CA (US); Yuki KATOH, San Jose, CA (US); Aram YANG, San Jose, CA (US); Jessa SILVER, San Jose, CA (US)

(21) Appl. No.: 19/420,377

(22) Filed: Dec. 15, 2025

Related U.S. Application Data
(63) Continuation of application No. PCT/US2024/034552, filed on Jun. 18, 2024.
(60) Provisional application No. 63/509,126, filed on Jun. 20, 2023.

(51) Int. Cl. H01M 4/36; C01G 53/42; C01G 53/506; H01M 4/525; H01M 4/62; H01M 10/42

(52) U.S. Cl. CPC H01M 4/366; C01G 53/42; C01G 53/506; H01M 4/525; H01M 4/62; H01M 10/4235; C01P 2002/54; C01P 2004/04; C01P 2004/80; C01P 2006/40

(57) ABSTRACT

The present disclosure concerns lithium phosphate species for coated cathode active materials, which are useful in cathodes (i.e., positive electrodes) of rechargeable lithium-batteries for reversibly storing lithium ions (Li⁺).

### CROSS-REFERENCE TO RELATED APPLICATIONS

The application is a continuation of PCT/US2024/034552 filed on Jun. 18, 2024, which claims priority to, and the benefit of, U.S. Provisional Patent Application No. 63/509,126, filed Jun. 20, 2023, the entire contents of which are herein incorporated by reference in its entirety for all purposes.

### FIELD

The present disclosure concerns lithium phosphate species for coated cathode active materials, which are useful in cathodes (i.e., positive electrodes) of rechargeable lithium-batteries for reversibly storing lithium ions (Li).

### BACKGROUND

There is currently an unmet need in the rechargeable lithium battery field directed to cathode active materials which are stable at high voltage (e.g., 4.2 V versus lithium metal) and/or high temperature (e.g., 60° C.). The instability tends to result in increases in internal resistance in the battery, when the battery is stored, in a charged state, or when the battery is used, or both.

Some solid electrolyte materials tend not to be stable at high voltage or high temperature. Solid electrolyte materials may react with cathode active materials. Cathode active materials may also oxidize when exposed to high voltage or high temperature. These are a few of the reasons for battery performance degradation. Some researchers have tried to coat cathode active materials with LiNbO₃, Li₂ZrO₃, and LiTaO₃ to prevent this oxidative. See for example, US 2016/0156021 A1; US 2019/0044146 A1; and U.S. Pat. No. 9,692,041 B2. See also Chem. Mater. 2018, 30, 22, 8190-8200, (doi.org/10.1021/acs.chemmater.8b03321); Adv. Energy Mater. 2020, 10, 1903778 (doi.org/10.1002/aenm.201903778); and Journal of Power Sources Volume 248, 15 Feb. 2014, Pages 943-950, (doi.org/10.1016/j.jpowsour.2013.10.005). However, these previously reported coatings had poor stability and/or suffered from other disadvantages. For example, at potentials as high as 4.2V (vs Li/Li+), the internal resistance of these coatings increased rapidly when in a charged state. For these and other reasons, these previously reported coatings were inferior in several regards. Heating the cathode is another way to prevent oxidation, and researchers have studied the effect of heating temperature on battery performance. Generally higher temperatures in the range of 750° C.-800° C. result in better performance (Lee, S. H., et al. Journal of Power Sources 184 (2008) 276-283 and Tang, Z. et al., Journal of Alloys and Compounds 693 (2017) 1157-1163). As reported in U.S. Pat. No. 9,972,826, heating temperatures in the range of 400-650° C. lead to reduced resistance in a battery compared to heating temperatures of 300° C.-350° C. and 700° C. However, high heating temperatures require large amounts of energy, which increases costs and consumption of fuels to generate energy, and can potentially be harmful to the cathode.

It would be advantageous to develop an energy efficient process for mitigating unwanted reactions within the cathode. Set forth herein are methods of preventing unwanted reactions within the cathode.

### SUMMARY

Set forth herein is a process for making cathode active material particles coated with a lithium phosphate species, the process comprising: 1) coating cathode active material particles with a reaction mixture comprising a lithium precursor, a phosphorus precursor, and a solvent, wherein the molar ratio of Li:P in the reaction mixture is about 3:1 to 1:3; 2) removing the solvent from the reaction mixture; and 3) heating the cathode active material particles at a temperature from about 250° C. to 375° C., under dry air conditions or an O₂ atmosphere, to form cathode active material particles coated with a lithium phosphate species. In one embodiment, the molar ratio of Li:P in the reaction mixture is about 3:1 to 3:3. In one embodiment, the phosphorus precursor is P₂O₅. In one embodiment, the temperature is from about 350° C. to 375° C. In one embodiment, the temperature is from about 300° C. to 350° C. In one embodiment, the temperature is from about 250° C. to 300° C. In one embodiment, the temperature is about 375° C. In one embodiment, the temperature is about 350° C. In one embodiment, the temperature is about 300° C. In one embodiment, the temperature is about 250° C.

Also forth herein is a composition comprising cathode active material particles and a coating in contact with the cathode active material particles, wherein the coating comprises a lithium phosphate species, wherein the cathode active material particles were coated using a reaction mixture comprising a lithium precursor and a phosphorous precursor at a Li:P molar ratio of about 3:1 to 1:3 at a temperature from about 250° C. to 375° C. In one embodiment, the molar ratio of Li:P in the reaction mixture is about 3:1 to 3:3. In one embodiment, the molar ratio of Li:P in the reaction mixture is about 3:1. In one embodiment, the molar ratio of Li:P in the reaction mixture is about 3:2. In one embodiment, the temperature is from about 350° C. to 375° C. In one embodiment, the temperature is from about 300° C. to 350° C. In one embodiment, the temperature is from about 250° C. to 300° C. In one embodiment, the temperature is about 375° C. In one embodiment, the temperature is about 350° C. In one embodiment, the temperature is about 300° C. In one embodiment, the temperature is about 250° C.

### BRIEF DESCRIPTION OF FIGURES

FIG. 1 is a non-limiting embodiment of a schematic of the spray coating process, showing one non-limiting method for producing the coated active materials described herein.

FIG. 2 is a graph comparing the median ASR change of a battery made with Cathode 1 (ratio of Li:P in starting material of 3:2 at a temperature of 250° C.) and a battery made from an uncoated cathode over the course of 3 months.

FIG. 3A is a graph showing the effect of heating temperature of Cathodes 7-10 (ratio of Li:P of 3:1) on median ASR change over the course of 28 days (where each data point represents the average of at least 30 experiments).

FIG. 3B is a graph showing the effect of heating temperature of Cathodes 7-10 (ratio of Li:P of 3:1) on median ASR change over the course of 28 days (where each data point represents the average of at least 60 experiments).

FIG. 4A is a graph showing the effect of heating temperature (250° C. and 375° C.) of Cathodes 1, 3 (ratio of Li:P of 3:2) on median ASR change over time (where each data point represents the average of at least 5 experiments).

FIG. 4B is a graph showing the effect of heating temperature (250° C. and 375° C.) of Cathodes 1, 3 (ratio of Li:P of 3:2) on median ASR change over time (where each data point represents the average of at least 50 experiments).

FIG. 5A is a graph showing the effect of heating temperature (250° C. and 375° C.) of the cathode and ratio of the starting material (ratio of Li:P of 3:1 and 3:2) on median ASR change over the course of 56 days (where each data point represents the average of at least 5 experiments).

FIG. 5B is a graph showing the effect of heating temperature (250° C. and 375° C.) of the cathode and ratio of the starting material (ratio of Li:P of 3:1 and 3:2) on median ASR change over the course of 178 days (where each data point represents the average of at least 40 experiments).

FIG. 6A is a graph showing the effect of concentration of cathode coating starting material on median ASR change (where each data point represents the average of at least 5 experiments).

FIG. 6B is a graph showing the effect of concentration of cathode coating starting material on median ASR change (where each data point represents the average of at least 20 experiments).

FIG. 7A is a graph showing the effect of the ratio of the starting material (ratio of Li:P of 3:1, 3:2, and 3:3) on median ASR change over the course of 56 days (where each data point represents the average of at least 5 experiments).

FIG. 7B is a graph showing the effect of the ratio of the starting material (ratio of Li:P of 3:1, 3:2, and 3:3) on median ASR change over the course of 178 days (where each data point represents the average of at least 40 experiments).

FIG. 8 is a graph comparing the discharge capacity change of a battery made with Cathode 1 and a battery made from an uncoated cathode over the course of 3 months.

FIG. 9 is a graph comparing the gas evolution of a battery made with Cathodes 1, 7, and 12 and a battery made from an uncoated cathode over the course of 2 days.

FIG. 10 is a transmission electron microscopy (TEM) image of an NMC core coated with a lithium phosphate species at a temperature of 250° C. The lithium phosphate species coating has a thickness of about 2.5 nm and is amorphous, as determined by TEM.

FIG. 11 is a TEM image of an NMC core coated with a lithium phosphate species at a temperature of 250° C. The lithium phosphate species coating has a thickness of about 11.5 nm to 15.9 nm and is amorphous, as determined by TEM.

FIG. 12 is a TEM image of an NMC core coated with a lithium phosphate species at a temperature of 375° C. The lithium phosphate species coating is crystalline, as determined by TEM.

FIG. 13 is a TEM image of an NMC core coated with a lithium phosphate species where the coating is discontinuous, as determined by TEM.

### DETAILED DESCRIPTION

### Definitions

As used herein, the term “about,” when qualifying a number, e.g., about 15% w/w, refers to the number qualified and optionally the numbers included in a range about that qualified number that includes ±10% of the number. For example, about 15% w/w includes 15% w/w as well as 13.5% w/w, 14% w/w, 14.5% w/w, 15.5% w/w, 16% w/w, or 16.5% w/w. For example, “about 75° C.” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein the phrase “dry air,” refers to air with a reduced amount of humidity. Dry air may be supplied in a clean room. Dry air is characterized as having a dew point less than −70° C.

As used herein the phrase “cathode active material,” refers to a material which can intercalate lithium ions or react with lithium ions in a reversible manner. The cathode active material is not particularly limited herein, and a publicly known, prior art cathode active material utilized in all-solid-state batteries can be used. In particular, if a metal oxide is used as the cathode active material, sintering of the secondary battery can be performed in an oxygen-containing atmosphere. Specific examples of such a cathode active material include the following: manganese oxide (MnO), iron oxides, copper oxides, nickel oxides, lithium-manganese complex oxides (e.g., LiₓMn₂O₄ or LiₓMnO₂), lithium-nickel complex oxides (e.g., LiₓNiO₂), lithium-cobalt complex oxides (e.g. LiₓCoO₂), lithium cobalt nickel oxides (LiNi_{1-y}Co_{y}O₂), lithium-manganese-cobalt complex oxides (e.g., LiMnyCo_{1-y}O₂), spinel-phase lithium-manganese-nickel complex oxides (e.g., LiₓMn_{2-y}NiyO₄), lithium phosphates having an olivine structure (e.g., LiₓFePO₄, LiₓFe_{1-y}Mn_{y}PO₄, LiₓCoPO₄), lithium phosphates having a NASICON-type structure (e.g., Li₇V₂(PO₄)₃), iron (III) sulfate (Fe₂(SO₄)₃), and vanadium oxides (e.g., V₂O₅). One type thereof can be used alone, or two or more types thereof can be used in combination. Preferably, x and y in these chemical formulas lie within the ranges of 1<x<5, and 0<y<1. Among the above, LiCoO₂, LiₓV₂(PO₄)₃, LiNiPO₄, and LiFePO₄ are preferred.

Additional examples of cathode active material include LiMPO₄ (M=Fe, Ni, Co, Mn); LiₓFe_{(1-y)}Mn_{y}PO₄, wherein 1≤x≤5 and 0≤y≤1; LixTiyOz, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNixCoyAlzO₂, wherein x+y+z=1, and 0≤x≤1, 0≤y≤1, and 0≤z≤1. In these formula, x, y, and z are chosen so that the formula is charge neutral. In one embodiment, the cathode active material is selected from a member of the NMC class of cathode active materials (including, but not limited to, LiNiCoMnO₂); the LFP class of cathode active materials (including, but not limited to, LiFePO₄/C); the LNMO class of cathode active materials (including, but not limited to, LiNi_{0.5}Mn_{1.5}O₄); the NCA class of cathode active materials (including, but not limited to, LiMn₂O₄ and LiMn₂O₂); the LMO class of cathode active materials (including, but not limited to, LiMn₂O₄); the LCO class of cathode active materials (including, but not limited to, LiCoO₂), or any cathode active material described in Minnmann et al. Advanced Energy Materials, 2022, 12, 2201425).

As used herein the phrase “characterized as having an x-ray powder diffraction (XRD) pattern having peaks at least at,” means that when the material is analyzed using x-ray powder diffraction, according to the techniques in the Examples, the sample will be observed to have at least the recited XRD peaks and possibly other peaks. Peaks are places of high intensity in the XRD pattern which are indicative of d-spacing (lattice spacing) of the crystalline unit cell which is inducing the observed XRD pattern when x-rays are incident upon the material being analyzed by XRD.

As used herein the phrase “as determined by XPS” means that when the material is analyzed by XPS as a loose powder, or X-ray photoelectron spectroscopy, according to the techniques in the Examples, the material will be observed to have the atomic percent ratio of element to element or functional group to functional group on the surface of the sample.

As used herein the phrase “solid-state cathode” refers to a cathode which does not include any liquid-phase electrolytes. As used herein, the terms “cathode” and “anode” refer to the electrodes of a battery. The cathode and anode are often referred to in the relevant field as the positive electrode and negative electrode, respectively. During a charge cycle in a Li-secondary battery, Li ions leave the cathode and move through an electrolyte, to the anode. During a charge cycle, electrons leave the cathode and move through an external circuit to the anode. During a discharge cycle in a Li-secondary battery, Li ions migrate towards the cathode through an electrolyte and from the anode. During a discharge cycle, electrons leave the anode and move through an external circuit to the cathode. As used herein, the phrase “positive electrode” refers to the electrode in a secondary battery towards which positive ions, e.g., Li⁺, conduct, flow or move during discharge of the battery. As used herein, the phrase “negative electrode” refers to the electrode in a secondary battery from where positive ions, e.g., Li⁺, flow or move during discharge of the battery. In a battery comprised of a Li-metal electrode and a conversion chemistry, intercalation chemistry, or combination conversion/intercalation chemistry-including electrode (i.e., cathode active material; e.g., NiFₓ, NCA, LiNiₓMn_{y}Co_{z}O₂ [NMC] or LiNiₓAl_{y}Co_{z}O₂ [NCA], wherein x+y+z=1), the electrode having the conversion chemistry, intercalation chemistry, or combination conversion/intercalation chemistry material is referred to as the positive electrode. In some usages, cathode is used in place of positive electrode, and anode is used in place of negative electrode. When a Li-secondary battery is charged, Li ions move from the positive electrode (e.g., NiFₓ, NMC, NCA) towards the negative electrode (e.g., Li-metal). When a Li-secondary battery is discharged, Li ions move towards the positive electrode and from the negative electrode.

As used herein the phrase “solid separator” refers to a Li⁺ ion-conducting material that is substantially insulating to electrons (e.g., the lithium ion conductivity is at least 10³ times, and often 10⁶ times, greater than the electron conductivity), and which acts as a physical barrier or spacer between the positive and negative electrodes in an electrochemical cell.

As used herein the phrase “stable at high voltage,” refers to a material (e.g., a coated cathode active material) which does not react at high voltage (4.2 V or higher versus Li metal) in a way that materially or significantly degrades the ionic conductivity or resistance of the material when held at high voltage for at least three days. Herein, a material or significant degradation in ionic conductivity or resistance is a reduction in ionic conductivity, or an increase in resistance, by an order of magnitude or more. As used herein, the term “high voltage” means at least 4.2 V versus lithium metal (i.e., v. Li). High voltage may also refer to higher voltage, e.g., 4.3, 4.4, 4.5, 4.6, 4.7, 4.8. 4.9, 5.0 V or higher.

As used herein, high voltage means 4.2 V or larger versus a lithium metal reference electrode (which is at 0 V) unless specified to the contrary.

As used herein the phrase “stable at high temperature,” refers to a material (e.g., a coated cathode active material) which does not react at high temperature (60° C. or higher) in a way that materially or significantly degrades the ionic conductivity or resistance of the material when held at high temperature for at least three days.

As used herein, area-specific resistance (ASR) is measured by electrochemical cycling using an Arbin or Biologic instrument unless otherwise specified to the contrary.

As used herein, ionic conductivity is measured by electrical impedance spectroscopy methods known in the art.

As used herein, the term “lithium phosphate species”, “LPO”, or “LPO species” refers to a species that comprises lithium, phosphorus, and oxygen.

As used herein, “% of the surface,” refers to the percent of geometric surface area for a particle. For example, “60% of the surface,” refers to 60% of the geometric surface of the cathode active material particles. For example, for a spherically shaped cathode active material particles, the geometric surface area is calculated as 4πr², wherein r is the radius of the spherically shaped particle. 60% of the surface would mean that (0.6)(4πr²) of the cathode active material particle is coated, and (0.4)(4πr²) of the cathode active material particle is not coated.

As used herein, the phrase “d₅₀ diameter” refers to the median size, in a distribution of sizes, measured by microscopy techniques or other particle size analysis techniques, such as, but not limited to, scanning electron microscopy or dynamic light scattering. “D₅₀” includes the characteristic dimension at which 50% of the particles are smaller than the recited size.

As used herein, the phrase “d₉₀ diameter” refers to a size, in a distribution of sizes, measured by microscopy techniques or other particle size analysis techniques, such as, but not limited to, scanning electron microscopy or dynamic light scattering. “D₉₀” includes the characteristic dimension at which 90% of the particles are smaller than the recited size.

As used herein, the phrase “O₂ atmosphere” refers to a gas atmosphere comprising at least 99% by volume (v/v) oxygen (O₂) gas, at least 99.5% v/v O₂ gas, at least 99.9% v/v O₂ gas, at least 99.99% v/v O₂ gas, or essentially pure O₂ gas.

As used herein, the phrase “dry air conditions” or “dry air” refers to air with a reduced amount of humidity. Dry air may be supplied in a clean room. Dry air is characterized as having a dew point (dp) less than −20° C., less than −30′ °, less than −40° C., less than −50° C., less than −6° C., or less than −70° C.

### Lithium Phosphate Species Cathode Coatings

Set forth herein are compositions comprising coated cathode active materials for cathodes in solid-state lithium rechargeable batteries. In some embodiments, the cathodes disclosed herein comprise a solid-state catholyte. In some embodiments, the cathodes disclosed herein comprise a liquid catholyte.

In some embodiments, the coated cathode active materials disclosed herein are used in cathodes comprising a solid-state catholyte. In some embodiments, the coated cathode active materials disclosed herein are used in cathodes comprising a liquid-state catholyte.

Set forth herein is a composition comprising cathode active material particles and a coating in contact with the cathode active material particles, wherein the coating comprises a lithium phosphate species, wherein the cathode active material particles were coated using a reaction mixture comprising a lithium precursor and a phosphorous precursor at a Li:P molar ratio of about 3:1 to 1:3 at a temperature from 150° C. to 375° C. In some embodiments, the molar ratio of Li:P in the reaction mixture is about 3:1 to 3:3. In one embodiment, the molar ratio of Li:P in the reaction mixture is about 3:1. In one embodiment, the molar ratio of Li:P in the reaction mixture is about 3:1.5. In one embodiment, the molar ratio of Li:P in the reaction mixture is about 3:2. In one embodiment, the molar ratio of Li:P in the reaction mixture is about 1:3. In one embodiment, the molar ratio of Li:P in the reaction mixture is about 2:3. In one embodiment, the temperature is from about 150° C. to 350° C. In one embodiment, the temperature is from about 150° C. to 300° C. In one embodiment, the temperature is from about 150° C. to 250° C. In one embodiment, the temperature is between about 250° C. to 375° C. In one embodiment, the temperature is from about 350° C. to 375° C. In one embodiment, the temperature is between about 300° C. to 350° C. In one embodiment, the temperature is between about 250° C. to 300° C. In one embodiment, the temperature is about 375° C. In one embodiment, the temperature is about 350° C. In one embodiment, the temperature is about 300° C. In one embodiment, the temperature is about 250° C. In one embodiment, the temperature is about 150° C.

In one embodiment, the lithium phosphate species is a reaction product of LiOEt and a phosphorus precursor wherein the molar ratio of Li:P in the reaction mixture is about 3:1 and the lithium phosphate species is a product of heating at about 150° C. In one embodiment, the lithium phosphate species is a reaction product of LiOEt and a phosphorus precursor wherein the molar ratio of Li:P in the reaction mixture is about 3:1 and the lithium phosphate species is a product of heating at about 250° C. In one embodiment, the lithium phosphate species is a reaction product of LiOEt and a phosphorus precursor wherein the molar ratio of Li:P in the reaction mixture is about 3:1 and the lithium phosphate species is a product of heating at about 300° C. In one embodiment, the lithium phosphate species is a reaction product of LiOEt and a phosphorus precursor wherein the molar ratio of Li:P in the reaction mixture is about 3:1 and the lithium phosphate species is a product of heating at about 350° C. In one embodiment, the lithium phosphate species is a reaction product of LiOEt and a phosphorus precursor wherein the molar ratio of Li:P in the reaction mixture is about 3:1 and the lithium phosphate species is a product of heating at about 375° C.

In one embodiment, the lithium phosphate species is a reaction product of LiOEt and a phosphorus precursor wherein the molar ratio of Li:P in the reaction mixture is about 3:1.5 and the lithium phosphate species is a product of heating at about 150° C. In one embodiment, the lithium phosphate species is a reaction product of LiOEt and a phosphorus precursor wherein the molar ratio of Li:P in the reaction mixture is about 3:1.5 and the lithium phosphate species is a product of heating at about 250° C. In one embodiment, the lithium phosphate species is a reaction product of LiOEt and a phosphorus precursor wherein the molar ratio of Li:P in the reaction mixture is about 3:1.5 and the lithium phosphate species is a product of heating at about 300° C. In one embodiment, the lithium phosphate species is a reaction product of LiOEt and a phosphorus precursor wherein the molar ratio of Li:P in the reaction mixture is about 3:1.5 and the lithium phosphate species is a product of heating at about 350° C. In one embodiment, the lithium phosphate species is a reaction product of LiOEt and a phosphorus precursor wherein the molar ratio of Li:P in the reaction mixture is about 3:1.5 and the lithium phosphate species is a product of heating at about 375° C.

In one embodiment, the lithium phosphate species is a reaction product of LiOEt and a phosphorus precursor wherein the molar ratio of Li:P in the reaction mixture is about 3:2 and the lithium phosphate species is a product of heating at about 150° C. In one embodiment, the lithium phosphate species is a reaction product of LiOEt and a phosphorus precursor wherein the molar ratio of Li:P in the reaction mixture is about 3:2 and the lithium phosphate species is a product of heating at about 250° C. In one embodiment, the lithium phosphate species is a reaction product of LiOEt and a phosphorus precursor wherein the molar ratio of Li:P in the reaction mixture is about 3:2 and the lithium phosphate species is a product of heating at about 300° C. In one embodiment, the lithium phosphate species is a reaction product of LiOEt and a phosphorus precursor wherein the molar ratio of Li:P in the reaction mixture is about 3:2 and the lithium phosphate species is a product of heating at about 350° C. In one embodiment, the lithium phosphate species is a reaction product of LiOEt and a phosphorus precursor wherein the molar ratio of Li:P in the reaction mixture is about 3:2 and the lithium phosphate species is a product of heating at about 375° C.

In one embodiment, the lithium phosphate species is a reaction product of LiOEt and a phosphorus precursor wherein the molar ratio of Li:P in the reaction mixture is about 2:3 and the lithium phosphate species is a product of heating at about 150° C. In one embodiment, the lithium phosphate species is a reaction product of LiOEt and a phosphorus precursor wherein the molar ratio of Li:P in the reaction mixture is about 2:3 and the lithium phosphate species is a product of heating at about 250° C. In one embodiment, the lithium phosphate species is a reaction product of LiOEt and a phosphorus precursor wherein the molar ratio of Li:P in the reaction mixture is about 2:3 and the lithium phosphate species is a product of heating at about 300° C. In one embodiment, the lithium phosphate species is a reaction product of LiOEt and a phosphorus precursor wherein the molar ratio of Li:P in the reaction mixture is about 2:3 and the lithium phosphate species is a product of heating at about 350° C. In one embodiment, the lithium phosphate species is a reaction product of LiOEt and a phosphorus precursor wherein the molar ratio of Li:P in the reaction mixture is about 2:3 and the lithium phosphate species is a product of heating at about 375° C.

In one embodiment, the lithium phosphate species is a reaction product of LiOEt and a phosphorus precursor wherein the molar ratio of Li:P in the reaction mixture is about 1:3 and the lithium phosphate species is a product of heating at about 150° C. In one embodiment, the lithium phosphate species is a reaction product of LiOEt and a phosphorus precursor wherein the molar ratio of Li:P in the reaction mixture is about 1:3 and the lithium phosphate species is a product of heating at about 250° C. In one embodiment, the lithium phosphate species is a reaction product of LiOEt and a phosphorus precursor wherein the molar ratio of Li:P in the reaction mixture is about 1:3 and the lithium phosphate species is a product of heating at about 300° C. In one embodiment, the lithium phosphate species is a reaction product of LiOEt and a phosphorus precursor wherein the molar ratio of Li:P in the reaction mixture is about 1:3 and the lithium phosphate species is a product of heating at about 350° C. In one embodiment, the lithium phosphate species is a reaction product of LiOEt and a phosphorus precursor wherein the molar ratio of Li:P in the reaction mixture is about 1:3 and the lithium phosphate species is a product of heating at about 375° C.

In one embodiment, the lithium phosphate species is a reaction product of 0.0074 mol of LiOEt and 0.0025 mol of a phosphorus precursor. In one embodiment, the lithium phosphate species is a reaction product of 0.0147 mol of LiOEt and 0.0049 mol of a phosphorus precursor. In one embodiment, the lithium phosphate species is a reaction product of 0.0294 mol of LiOEt and 0.0980 mol of a phosphorus precursor.

In some embodiments, the lithium phosphate species comprises a compound of the formula LiₓP_{y}O_{z}, wherein 1.0≤x≤4.0, 0≤y≤2.0, and 2.0≤z≤7.0, and wherein the formula is charge neutral. In some embodiments, the lithium phosphate species comprises a compound of the formula LiₓP_{y}O_{z}, wherein 0.6≤x≤1.5, 0.5≤y≤1.4, and 2.0≤z≤3.7, and wherein the formula is charge neutral.

In some embodiments, the lithium phosphate species is Li₃PO₄, LiPO₃, Li₄P₂O₇, a mixture of Li₄P₂O₇ and Li₃PO₄ (i.e., Li₄P₂O₇/Li₃PO₄), a mixture of Li₄P₂O₇ and LiPO₃ (i.e., Li₄P₂O₇/LiPO₃), a lithium organophosphate, or combinations thereof. In some embodiments, the lithium phosphate species is Li₃PO₄. In some embodiments, the lithium phosphate species is LiPO₃. In some embodiments, the lithium phosphate species is Li₄P₂O₇/Li₃PO₄. In some embodiments, the lithium phosphate species is Li₄P₂O₇/LiPO₃. In some embodiments, the lithium phosphate species is a lithium organophosphate. In some embodiments, the lithium organophosphate is lithium diethylphosphate, lithium dimethylphosphate, lithium diisopropylphosphate, lithium ethyl methyl phosphate, lithium ethyl isopropyl phosphate, lithium methyl isopropyl phosphate, dilithium methylphosphate, dilithium ethylphosphate, dilithium isopropylphosphate or combinations thereof.

In some embodiments, the lithium phosphate species is crystalline, amorphous, or combinations thereof. In some embodiments, the lithium phosphate species is crystalline. In some embodiments, the lithium phosphate species is amorphous. In some embodiments, the lithium phosphate species is crystalline and amorphous.

In some embodiments, the lithium phosphate species is crystalline Li₃PO₄. In some embodiments, the lithium phosphate species is amorphous Li₃PO₄. In some embodiments, the lithium phosphate species is crystalline Li₃PO₄ and amorphous Li₃PO₄. In some embodiments, the lithium phosphate species is crystalline LiPO₃. In some embodiments, the lithium phosphate species is amorphous LiPO₃. In some embodiments, the lithium phosphate species is crystalline LiPO₃ and amorphous LiPO₃. In some embodiments, the lithium phosphate species is crystalline Li₄P₂O₇. In some embodiments, the lithium phosphate species is amorphous Li₄P₂O₇. In some embodiments, the lithium phosphate species is crystalline Li₄P₂O₇ and amorphous Li₄P₂O₇. In some embodiments, the lithium phosphate species is a mixture of crystalline Li₄P₂O₇ and crystalline Li₃PO₄ (i.e., crystalline Li₄P₂O₇/Li₃PO₄). In some embodiments, the lithium phosphate species is a mixture of amorphous Li₄P₂O₇ and amorphous Li₃PO₄ (i.e., amorphous Li₄P₂O₇/Li₃PO₄). In some embodiments, the lithium phosphate species is a mixture of crystalline Li₄P₂O₇/Li₃PO₄ and amorphous Li₄P₂O₇/Li₃PO₄. In some embodiments, the lithium phosphate species is crystalline Li₄P₂O₇/LiPO₃. In some embodiments, the lithium phosphate species is amorphous Li₄P₂O₇/LiPO₃. In some embodiments, the lithium phosphate species is crystalline Li₄P₂O₇/LiPO₃ and amorphous Li₄P₂O₇/LiPO₃.

In one embodiment, including any of the foregoing, the phosphorus precursor is selected from P₂O₅, H₃PO₄, (NH₄)₃PO₄, (NH₃)₃PO₄, diethylphosphate, dimethylphosphate or combinations thereof. In one embodiment, including any of the foregoing, the lithium precursor is selected from lithium hydroxide (LiOH), lithium ethoxide (LiOEt), lithium methoxide (LiOMe), metallic lithium, and combinations thereof. In one embodiment, including any of the foregoing, the phosphorus precursor is a sol-gel precursor, such as a phosphorus alkoxide precursor. In one embodiment, the phosphorus precursor is P₂O₅. In one embodiment, the lithium precursor is LiOH. In one embodiment, the lithium precursor is LiOEt.

In one embodiment, the coating is a discontinuous layer. In one embodiment, the coating is a continuous layer. In one embodiment, the coating is amorphous. In one embodiment, the coating is crystalline. In one embodiment, the coating comprises crystalline domains as determined by TEM analysis. In one embodiment, the coating comprises amorphous domains as determined by TEM analysis. In one embodiment, the coating comprises crystalline domains and amorphous domains as determined by TEM analysis.

Certain of these coatings may prevent, or delay, the aforementioned unwanted reactions which were noted as a reason for battery performance degradation. When used in batteries, the newly disclosed coated cathode active materials set forth herein result in more stable batteries.

In one embodiment, the coating is lattice matched with the cathode active material. In one embodiment, the coating has a surface that is crystalline. In one embodiment, the coating has a surface that is amorphous. In one embodiment, the coating is a coating that is continuous. In one embodiment, the coating is a coating that is discontinuous.

Herein coating refers to a material bonded to the cathode active material, and not the cathode active material itself, even when the cathode active materials are an oxide, unless specified otherwise explicitly to the contrary herein. For example, NMC is an oxide. However, set forth herein are other coatings which bond to the NMC oxide. These other coatings, which are different from the NMC oxide, which is the cathode active material particles, are described above and below.

In one embodiment, including any of the foregoing, the coating further comprises amorphous domains based on transmission electron microscopy (TEM) analysis. In one embodiment, including any of the foregoing, the coating further comprises crystalline domains based on transmission electron microscopy (TEM) analysis. In one embodiment, including any of the foregoing, the coating further comprises amorphous domains based on transmission electron microscopy (TEM) analysis in addition to the crystalline domains based on transmission electron microscopy analysis.

In one embodiment, including any of the foregoing, the crystalline domains are in contact with the cathode active material.

In one embodiment, including any of the foregoing, the amorphous domains are in contact with the cathode active material.

In one embodiment, including any of the foregoing, the amorphous domains are not in contact with the cathode active material.

In one embodiment, including any of the foregoing, the crystalline domains are in contact with the cathode active material and the amorphous domains are in contact with the crystalline domains.

In one embodiment, including any of the foregoing, the amorphous domains are in contact with the cathode active material and the crystalline domains are in contact with the amorphous domains.

In one embodiment, including any of the foregoing, the coating is continuous. In one embodiment, the coating is discontinuous.

In certain embodiments, including any of the foregoing, the coating has a thickness, T, as determined by TEM analysis, that is 1 nm≤T≤20 nm. In certain embodiments, including any of the foregoing, the coating has a thickness, T, as determined by TEM analysis, that is 1 nm≤T≤10 nm. In certain embodiments, including any of the foregoing, the coating has a thickness, T, as determined by TEM analysis, that is 1 nm≤T≤3 nm.

In certain embodiments, including any of the foregoing, the coating has a thickness, T, as determined by TEM analysis, that is less than 1 nm.

In certain embodiments, including any of the foregoing, the coating has a thickness, T, as determined by scanning electron microscopy (SEM) analysis, that is 1 nm≤T≤20 nm.

In certain embodiments, including any of the foregoing, T is about 1 nm, about 5 nm, or about 10 nm. In one embodiment, including any of the foregoing, T is about 1 nm. In one embodiment, including any of the foregoing, T is about 2 nm. In one embodiment, including any of the foregoing, T is about 3 nm. In one embodiment, including any of the foregoing, T is about 4 nm. In one embodiment, including any of the foregoing, T is about 5 nm. In certain embodiments, including any of the foregoing, T is about 6 nm. In one embodiment, including any of the foregoing, T is about 7 nm. In one embodiment, including any of the foregoing, T is about 8 nm. In one embodiment, including any of the foregoing, T is about 9 nm. In one embodiment, including any of the foregoing, T is about 10 nm. In another embodiment, including any of the foregoing, T is about 11 nm. In another embodiment, including any of the foregoing, T is about 12 nm.

In certain embodiments, including any of the foregoing, T is from about 0.8 nm and 10 nm. In one embodiment, including any of the foregoing, T is from about 0.8 nm and 5 nm. In one embodiment, including any of the foregoing, T is from about 0.8 nm and 2.5 nm. In one embodiment, including any of the foregoing, T is from about 0.8 nm and 1.5 nm. In one embodiment, including any of the foregoing, T is from about 1 nm and 4 nm. In one embodiment, including any of the foregoing, T is from about 1.5 nm and 3.5 nm. In other embodiments, including any of the foregoing, T is from about 5 nm and 10 nm. In one embodiment, including any of the foregoing, T is from about 7 nm and 10 nm.

In certain embodiments, including any of the foregoing, the coating is not an even layer and T can range in thicknesses from about 0.8 nm to 12 nm. In one embodiment, including any of the foregoing, T ranges in thickness from about 0.8 nm to 5 nm. In one embodiment, including any of the foregoing, T ranges in thickness from about 1 nm to 3.5 nm. In one embodiment, including any of the foregoing, T ranges in thickness from about 1.5 nm to 4 nm. In one embodiment, including any of the foregoing, T ranges in thickness from about 5 nm to 12 nm. In one embodiment, including any of the foregoing, T ranges in thickness from about 5 nm to 8 nm.

In certain embodiments, including any of the foregoing, T is less than about 12 nm. In certain embodiments, including any of the foregoing, T is less than about 11 nm. In certain embodiments, including any of the foregoing, T is less than about 10 nm. In certain embodiments, including any of the foregoing, T is less than about 9 nm. In certain embodiments, including any of the foregoing, T is less than about 8 nm. In certain embodiments, including any of the foregoing, T is less than about 7 nm. In certain embodiments, including any of the foregoing, T is less than about 6 nm. In certain embodiments, including any of the foregoing, T is less than about 5 nm. In certain embodiments, including any of the foregoing, T is less than about 4 nm. In certain embodiments, including any of the foregoing, T is less than about 3 nm. In certain embodiments, including any of the foregoing, T is less than about 2 nm. In certain embodiments, including any of the foregoing, T is less than about 1 nm.

In certain embodiments, including any of the foregoing, T is not thicker than the TEM can detect, for example as described herein.

In certain embodiments, including any of the forgoing, the coating comprises both crystalline and amorphous domains and the thickness of the crystalline domain is from about 0.8 nm and 5 nm and the thickness of the amorphous domain is from about 0.8 nm and 5 nm. In one embodiment, the thickness of the crystalline domain is from about 1 nm and 3 nm and the thickness of the amorphous domain is from about 1 nm and 4 nm. In one embodiment, the thickness of the crystalline domain is from about 1.5 nm and 2.5 nm and the thickness of the amorphous domain is from about 2 nm and 4 nm. In one embodiment, the thickness of the crystalline domain is less than the thickness of the amorphous domain. In another embodiment, the thickness of the crystalline domain is greater than the thickness of the amorphous domain. In certain embodiments, including any of the foregoing, the crystalline domain is in contact with the cathode active material and the amorphous domain is in contact with the crystalline domain.

In any of the foregoing embodiments, the thickness is +20% of the described thickness. In any of the foregoing embodiments, the thickness is +10% of the described thickness.

In one embodiment, including any of the foregoing, the coating crystalline domains do not lattice match the crystalline domains of the cathode active material, as determined by TEM analysis.

In one embodiment, including any of the foregoing, the coating crystalline domains do not lattice match the crystalline domains of the cathode active material, as determined by SEM analysis.

In one embodiment, including any of the foregoing, the coating crystalline domains do lattice match the crystalline domains of the cathode active material, as determined by TEM analysis.

In one embodiment, including any of the foregoing, the coating crystalline domains do lattice match the crystalline domains of the cathode active material, as determined by SEM analysis.

In one embodiment, including any of the foregoing, the coating further comprises carbonate. In one embodiment, including any of the foregoing, the coating further comprises lithium carbonate.

In some embodiments, the composition comprises a cathode active material that is doped with zirconium. In some embodiments, the cathode active material is Zr-doped LiNiₓMn_{y}Co_{z}O₂, x+y+z=1, 0.80≤x≤1, 0≤y≤1, and 0≤z≤1, wherein x+y+z=1. In some embodiments, the cathode active material is Zr-doped LiNixMnyCo_{z}O₂, x+y+z=1, 0.80≤x≤0.90, 0≤y≤0.2, and 0≤z≤0.2, wherein x+y+z=1. In some embodiments, the composition comprising a coated cathode active material has a ratio of CO₃:Zr of less than 15 as measured by x-ray photoelectron spectroscopy (XPS). In some embodiments, the composition comprising a coated cathode active material has a ratio of CO₃:Zr of less than 10 as measured by XPS. In some embodiments, the composition comprising a coated cathode active material has a ratio of CO₃:Zr of less than 5 as measured by XPS. In some embodiments, the composition comprising a coated cathode active material has a ratio of CO₃:Zr that is below the XPS detectable limit. In some embodiments, the composition comprising a coated cathode active material has a ratio of P:Zr of greater than 40 as measured by XPS. In some embodiments, the composition comprising a coated cathode active material has a ratio of P:Zr of greater than 50 as measured by XPS.

In one embodiment, including any of the foregoing, the composition further comprises a second coating in contact with the first coating wherein the first coating is in contact with the active cathode material particles. In one embodiment, including any of the foregoing, the second coating is not Li₃PO₄.

In one embodiment, including any of the foregoing, the second coating has a chemical formula which is not the same as the chemical formula of the coating.

In certain embodiments, including any of the foregoing, the second coating comprises a compound of the chemical formula: LiₓB_{y}O_{z}, wherein 0.2≤x≤0.75, 0.5≤y≤1.6, and 1.5≤z≤2.6; LiₓC_{y}O_{z}, wherein 0.4≤x≤1.8, 0.1≤y≤1, and 1≤z≤1.8; LiₓZr_{y}O_{z}, wherein 0≤x≤1.6, 0.2≤y≤1.0, and 2≤z≤1.2; LiₓP_{y}O_{z}, wherein 0.6≤x≤1.5, 0.5≤y≤1.4, and 2.0≤z≤3.7; LiₓZr_{y}(PO₄)_{z}, wherein 0.05≤x≤1.5, 1≤y≤3, and 2.0≤z≤4.0; LiₓNb_{y}O_{z}, wherein 0.5≤x≤1.5, 0.5≤y≤1.5, and 2≤z≤4; LiₓTi_{y}O_{z}, wherein 0 x≤1.6, 0.2≤y≤1.0, and 2≤z≤1.2; LiₓTi_{y}P_{w}O_{z}, wherein 0≤x≤2, 1≤y≤3, 1≤w≤4, and 2≤z≤20; LiₓZr_{y}P_{w}O_{z}, wherein 0≤x≤2, 1≤y≤3, 1≤w≤4, and 2≤z≤20; LiₓZr_{y}F_{z}, wherein 0.2≤x≤0.75, 0.25≤y≤0.8, and 1.75≤z≤3.4; LiₓTi_{y}F_{z}, wherein 0.2≤x≤0.75, 0.25≤y≤0.8, and 1.75≤z≤3.4; LiₓAl_{y}F_{z}, wherein 0.4≤x≤0.8, 0.2≤y≤0.6, and 1.4≤z≤2.2; LiₓY_{y}F_{z}, wherein 0.4≤x≤0.8, 0.2≤y≤0.6, and 1.4≤z≤2.2; LiₓNb_{y}F_{z}, wherein 0.2≤x≤0.8, 0.2≤y≤0.8, and 1.8≤z≤4.2; or combinations thereof. Subscripts x, y, and z, are selected so the compound is charge neutral. In certain embodiments, including any of the foregoing, the second coating comprises a compound of the formula: Li₂CO₃; Li₃BO₃; Li₃B₁₁O₁₈; Li₂ZrO₃; Li₃PO₄; Li₂SO₄; LiNbO₃; Li₄Ti₅O₁₂; LixTi₂(PO₄)₃; LiZr₂(PO₄)₃; LiOH; LiF; Li₄ZrF₈; Li₃Zr₄F₁₉; Li₃TiF₆; LiAlF₄; LiYF₄; LiNbF₆; ZrO₂; Al₂O₃; TiO₂; ZrF₄, AlF₃; TiF₄; YF₃; NbF₅; or combinations thereof.

In one embodiment, the second coating comprises Li₂CO₃. In one embodiment, the second coating comprises Li₃BO₃. In one embodiment, the second coating comprises Li₃B₁₁O₁₈. In one embodiment, the second coating comprises Li₂ZrO₃. In one embodiment, the second coating comprises Li₃PO₄. In one embodiment, the second coating comprises Li₂SO₄. In one embodiment, the second coating comprises LiNbO₃. In one embodiment, the second coating comprises Li₄Ti₅O₁₂. In one embodiment, the second coating comprises LixTi₂(PO₄)₃. In one embodiment, the second coating comprises LiZr₂(PO₄)₃. In one embodiment, the second coating comprises LiOH. In one embodiment, the second coating comprises LiF. In one embodiment, the second coating comprises Li₄ZrF₈. In one embodiment, the second coating comprises Li₃Zr₄F₁₉. In one embodiment, the second coating comprises Li₃TiF₆. In one embodiment, the second coating comprises LiAlF₄. In one embodiment, the second coating comprises LiYF₄. In one embodiment, the second coating comprises LiNbF₆. In one embodiment, the second coating comprises ZrO₂. In one embodiment, the second coating comprises Al₂O₃. In one embodiment, the second coating comprises TiO₂. In one embodiment, the second coating comprises ZrF₄. In one embodiment, the second coating comprises AlF₃. In one embodiment, the second coating comprises TiF₄. In certain examples, the second coating comprises YF₃. In one embodiment, the second coating comprises NbFs.

In one embodiment, including any of the foregoing, the second coating is amorphous as determined by TEM analysis. In one embodiment, including any of the foregoing, the second coating is crystalline as determined by TEM analysis. In one embodiment, including any of the foregoing, the second coating has a chemical formula which is not the same as the chemical formula of the coating. In one embodiment, including any of the foregoing, the second coating comprises Li₃BO₃. In one embodiment, including any of the foregoing, the second coating comprises LiₓB_{y}O_{z}, wherein 0.2≤x≤0.75, 0.5≤y≤1.6, and 1.5≤z≤2.6. In one embodiment, including any of the foregoing, the second coating comprises Li₂CO₃, Li₃BO₃, Li₃B₁₁O₁₈, LiₓB_{y}O_{z}, or combinations thereof. In the formula, LiₓB_{y}O_{z}, 0.2≤x≤0.75, 0.5≤y≤1.6, and 1.5≤z≤2.6. In one embodiment, including any of the foregoing the second coating comprises LiₓZr_{y}O_{z}, wherein 0≤x≤1.6, 0.2≤y≤1.0, and 2≤z≤1.2. In one embodiment, including any of the foregoing, the second coating comprises LiₓP_{y}O_{z}, wherein 0.6≤x≤1.5, 0.5≤y≤1.4, and 2.0≤z≤3.7. In one embodiment, including any of the foregoing, the second coating comprises Li₃InCl₆. In one embodiment, the first coating comprises a compound of the formula LiₓPₐO_{d}, wherein 0.05≤x≤1.5, 1.0≤a≤6.0, and 2.0≤d≤20.0 and wherein the formula is charge neutral. In one embodiment, the first coating comprises a compound of the formula LiₓPₐO_{d}, wherein 0.5≤x≤7.0, 1.0≤a≤4.0, and 5.0≤d≤14.0 and wherein the formula is charge neutral. In one embodiment, the first coating comprises a compound of the formula LiₓPₐO_{d}, wherein 0.5≤x≤2.0, 1.0≤a≤4.0, and 10.0≤d≤13.0 and wherein the formula is charge neutral. In one embodiment, the first coating comprises a compound of the formula LiₓPₐO_{d}, wherein 1.0≤x≤4.0, 1.0≤a≤3.0, and 4.0≤d≤7.0 and wherein the formula is charge neutral. In one embodiment, the first coating comprises a compound of the formula LiₓPₐO_{d}, wherein 1.0≤x≤3.0, 0≤a≤2.0, and 5.0≤d≤8.0 and wherein the formula is charge neutral. In one embodiment, the first coating comprises a compound of the formula LiₓPₐO_{d}, wherein 5.0≤x≤8.0, 0≤a≤2.0, and 6.0≤d≤9.0 and wherein the formula is charge neutral. In one embodiment, the first coating comprises a compound of the formula LiₓPₐO_{d}, wherein 2.0≤x≤4, 0≤a≤2.0, and 2.0≤d≤5.0 and wherein the formula is charge neutral. In certain embodiments, including any of the foregoing, the first coating comprises Li₃PO₄. In certain embodiments, the first coating comprises Li₃PO₄ and the second coating comprises a chemical formula selected from Li₃ZrPO₆, Li₅PZrO₇, Li₇ZrPO₈, Li₃PO₄, Li₂ZrO₃, or Li₂₄Zr₃P₁₄O₅₃. In one embodiment, the first coating comprises Li₃PO₄ and the second coating comprises a chemical formula of the formula LiₓZr_{y}PₐO_{d}, wherein 0.05≤x≤8.0, 0≤y≤3.0, 0≤a≤6.0; and 2.0≤d≤20.0 and wherein the formula is charge neutral and second coating is not Li₃PO₄. In one embodiment, the first coating comprises crystalline domains as measured by TEM and the second coating comprises crystalline or amorphous domains as measured by TEM. In one embodiment, the first coating comprises amorphous domains as measured by TEM and the second coating comprises crystalline or amorphous domains as measured by TEM. In one embodiment, the first coating comprises crystalline and amorphous domains as measured by TEM and the second coating comprises crystalline or amorphous domains as measured by TEM. Also set forth herein are coated cathode active material particles, comprising: cathode active material particles; wherein: the cathode active material particles comprise a first coating and a second coating; the first coating comprises Li₃PO₄; the second coating comprises Li₃BO₃, Li₃B₁₁O₁₈, LiₓB_{y}O_{z}, wherein 0.2≤x≤0.75, 0.5≤y≤1.6, and 1.5≤z≤2.6, or combinations thereof, and wherein: the first coating contacts the cathode active material particles; and the second coating contacts the first coating.

Also set forth herein are coated cathode active material particles, comprising: cathode active material particles; wherein: the cathode active material particles comprise a first coating and a second coating; the first coating comprises Li₃PO₄; the second coating comprises LiₓB_{y}O_{z}, wherein 0.2≤x≤0.75, 0.5≤y≤1.6, and 1.5≤z≤2.6, or combinations thereof, and wherein: the first coating contacts the cathode active material particles; and the second coating contacts the first coating.

Also set forth herein are coated cathode active material particles, comprising: cathode active material particles; wherein: the cathode active material particles comprise a first coating and a second coating; the first coating comprises Li₃PO₄ the second coating comprises Li₃BO₃, Li₃B₁₁O₁₈, or combinations thereof, and wherein: the first coating contacts the cathode active material particles; and the second coating contacts the first coating.

Also set forth herein are coated cathode active material particles, comprising: cathode active material particles; wherein: the cathode active material particles comprise a first coating and a second coating; the first coating comprises Li₃PO₄; the second coating comprises LiₓB_{y}O_{z}, wherein 0.2≤x≤0.75, 0.5≤y≤1.6, and 1.5≤z≤2.6; LiₓZr_{y}O_{z}, wherein 0 ≤x≤1.6, 0.2≤y≤1.0, and 2≤z≤1.2; LiₓP_{y}O_{z}, wherein 0.6≤x≤1.5, 0.5≤y≤1.4, and 2.0≤z≤3.7; or combinations thereof, and wherein: the first coating contacts the cathode active material particles; and the second coating contacts the first coating.

Also set forth herein are coated cathode active material particles, comprising: cathode active material particles; wherein: the cathode active material particles comprise a first coating and a second coating; the first coating comprises Li₃PO₄; the second coating comprises Li₃BO₃, Li₃B₁₁O₁₈, Li₂ZrO₃, LiZr₂(PO₄)₃, Li₂SO₄, LiₓByO_{z}, wherein 0.2≤x≤0.75, 0.5≤y≤1.6, and 1.5≤z≤2.6, or combinations thereof, and wherein: the first coating contacts the cathode active material particles; and the second coating contacts the first coating.

Also set forth herein are coated cathode active material particles, comprising: cathode active material particles; wherein: the cathode active material particles comprise a first coating and a second coating; the first coating comprises Li₃PO₄; the second coating comprises LiₓB_{y}O_{z}, wherein 0.2≤x≤0.75, 0.5≤y≤1.6, and 1.5≤z≤2.6; LiₓZr_{y}O_{z}, wherein 0≤x≤1.6, 0.2≤y≤1.0, and 2≤z≤1.2; LiₓP_{y}O_{z}, wherein 0.6 x≤5, 0.5≤y≤1.4, and 2.0≤z≤3.7 and second coating is not Li₃PO₄; and wherein: the first coating contacts the cathode active material particles; and the second coating contacts the first coating.

Also set forth herein are coated cathode active material particles, comprising: cathode active material particles; wherein: the cathode active material particles comprise a first coating and a second coating; the first coating comprises Li₃PO₄; the second coating comprises Li₃BO₃, Li₃B₁₁O₁₈, LZO, LiZr₂(PO₄)₃, Li₂SO₄, or combinations thereof, and wherein: the first coating contacts the cathode active material particles; and the second coating contacts the first coating.

Also set forth herein are coated cathode active material particles, comprising: cathode active material particles; wherein: the cathode active material particles comprise a first coating and a second coating; the first coating comprises Li₃PO₄; the second coating comprises Li₂CO₃, Li₃BO₃, Li₃B₁₁O₁₈, LiZr₂(PO₄)₃, Li₂SO₄, or combinations thereof, and wherein: the first coating contacts the cathode active material particles; and the second coating contacts the first coating.

Also set forth herein are coated cathode active material particles, comprising: cathode active material particles; wherein: the cathode active material particles comprise a first coating and a second coating; the first coating comprises Li₃PO₄; the second coating comprises Li₃BO₃; and wherein: the first coating contacts the cathode active material particles; and the second coating contacts the first coating.

Also set forth herein are coated cathode active material particles, comprising: cathode active material particles; wherein: the cathode active material particles comprise a first coating and a second coating; the first coating comprises Li₃PO₄; the second coating comprises LiZr₂(PO₄)₃; and wherein: the first coating contacts the cathode active material particles; and the second coating contacts the first coating.

Also set forth herein are coated cathode active material particles, comprising: cathode active material particles; wherein: the cathode active material particles comprise a first coating and a second coating; the first coating comprises Li₃PO₄; the second coating comprises Li₂SO₄; and wherein: the first coating contacts the cathode active material particles; and the second coating contacts the first coating.

In certain embodiments, including any of the foregoing, the thickness of each coating is about 1 nm to 50 nm. This means that in those examples where cathode active material particles have two coatings, each of the two coatings may have a thickness from 1 nm to 50 nm. Each coating may have the same or different thickness as the other coating. In one embodiment, one of the two coatings has a thickness of about 1 nm. In one embodiment, one of the two coatings has a thickness of about 2 nm. In one embodiment, one of the two coatings has a thickness of about 3 nm. In one embodiment, one of the two coatings has a thickness of about 4 nm. In one embodiment, one of the two coatings has a thickness of about 5 nm. In one embodiment, one of the two coatings has a thickness of about 6 nm. In one embodiment, one of the two coatings has a thickness of about 7 nm. In one embodiment, one of the two coatings has a thickness of about 8 nm. In one embodiment, one of the two coatings has a thickness of about 9 nm. In one embodiment, one of the two coatings has a thickness of about 10 nm. In one embodiment, one of the two coatings has a thickness of about 11 nm. In one embodiment, one of the two coatings has a thickness of about 12 nm. In one embodiment, one of the two coatings has a thickness of about 13 nm. In one embodiment, one of the two coatings has a thickness of about 14 nm. In one embodiment, one of the two coatings has a thickness of about 15 nm. In one embodiment, one of the two coatings has a thickness of about 16 nm. In one embodiment, one of the two coatings has a thickness of about17 nm. In one embodiment, one of the two coatings has a thickness of about 18 nm. In one embodiment, one of the two coatings has a thickness of about 19 nm. In one embodiment, one of the two coatings has a thickness of about 20 nm. In one embodiment, one of the two coatings has a thickness of about 21 nm. In one embodiment, one of the two coatings has a thickness of about 22 nm. In one embodiment, one of the two coatings has a thickness of 2about 3 nm. In one embodiment, one of the two coatings has a thickness of about 24 nm. In one embodiment, one of the two coatings has a thickness of about 25 nm. In one embodiment, one of the two coatings has a thickness of about 26 nm. In one embodiment, one of the two coatings has a thickness of about 27 nm. In one embodiment, one of the two coatings has a thickness of about 28 nm. In one embodiment, one of the two coatings has a thickness of about 29 nm. In one embodiment, one of the two coatings has a thickness of about 30 nm. In one embodiment, one of the two coatings has a thickness of about 31 nm. In one embodiment, one of the two coatings has a thickness of about 32 nm. In one embodiment, one of the two coatings has a thickness of about 33 nm. In one embodiment, one of the two coatings has a thickness of about 34 nm. In one embodiment, one of the two coatings has a thickness of about 35 nm. In one embodiment, one of the two coatings has a thickness of about 36 nm. In one embodiment, one of the two coatings has a thickness of about 37 nm. In one embodiment, one of the two coatings has a thickness of about 38 nm. In one embodiment, one of the two coatings has a thickness of about 39 nm. In one embodiment, one of the two coatings has a thickness of about 40 nm. In one embodiment, one of the two coatings has a thickness of about 41 nm. In one embodiment, one of the two coatings has a thickness of about 42 nm. In one embodiment, one of the two coatings has a thickness of about 43 nm. In one embodiment, one of the two coatings has a thickness of about 44 nm. In one embodiment, one of the two coatings has a thickness of about 45 nm. In one embodiment, one of the two coatings has a thickness of about 46 nm. In one embodiment, one of the two coatings has a thickness of about 47 nm. In one embodiment, one of the two coatings has a thickness of about 48 nm. In one embodiment, one of the two coatings has a thickness of about 49 nm. In one embodiment, one of the two coatings has a thickness of about 50 nm. In one embodiment, the second of the two coatings has a thickness of about 1 nm. In one embodiment, the second of the two coatings has a thickness of about 2 nm. In one embodiment, the second of the two coatings has a thickness of about 3 nm. In one embodiment, the second of the two coatings has a thickness of about 4 nm. In one embodiment, the second of the two coatings has a thickness of about 5 nm. In one embodiment, the second of the two coatings has a thickness of about 6 nm. In one embodiment, the second of the two coatings has a thickness of about 7 nm. In one embodiment, the second of the two coatings has a thickness of about 8 nm. In one embodiment, the second of the two coatings has a thickness of about 9 nm. In one embodiment, the second of the two coatings has a thickness of about 10 nm. In one embodiment, the second of the two coatings has a thickness of about 11 nm. In one embodiment, the second of the two coatings has a thickness of about 12 nm. In one embodiment, the second of the two coatings has a thickness of about 13 nm. In one embodiment, the second of the two coatings has a thickness of about 14 nm. In one embodiment, the second of the two coatings has a thickness of about 15 nm. In one embodiment, the second of the two coatings has a thickness of about 16 nm. In one embodiment, the second of the two coatings has a thickness of about 17 nm. In one embodiment, the second of the two coatings has a thickness of about 18 nm. In one embodiment, the second of the two coatings has a thickness of about 19 nm. In one embodiment, the second of the two coatings has a thickness of about 20 nm. In one embodiment, the second of the two coatings has a thickness of about 21 nm. In one embodiment, the second of the two coatings has a thickness of about 22 nm. In one embodiment, the second of the two coatings has a thickness of about 23 nm. In one embodiment, the second of the two coatings has a thickness of about 24 nm. In one embodiment, the second of the two coatings has a thickness of about 25 nm. In one embodiment, the second of the two coatings has a thickness of about 26 nm. In one embodiment, the second of the two coatings has a thickness of about 27 nm. In one embodiment, the second of the two coatings has a thickness of about 28 nm. In one embodiment, the second of the two coatings has a thickness of about 29 nm. In one embodiment, the second of the two coatings has a thickness of about 30 nm. In one embodiment, the second of the two coatings has a thickness of about 31 nm. In one embodiment, the second of the two coatings has a thickness of about 32 nm. In one embodiment, the second of the two coatings has a thickness of about 33 nm. In one embodiment, the second of the two coatings has a thickness of about 34 nm. In one embodiment, the second of the two coatings has a thickness of about 35 nm. In one embodiment, the second of the two coatings has a thickness of about 36 nm. In one embodiment, the second of the two coatings has a thickness of about 37 nm. In one embodiment, the second of the two coatings has a thickness of about 38 nm. In one embodiment, the second of the two coatings has a thickness of about 39 nm. In one embodiment, the second of the two coatings has a thickness of about 40 nm. In one embodiment, the second of the two coatings has a thickness of about 41 nm. In one embodiment, the second of the two coatings has a thickness of about 42 nm. In one embodiment, the second of the two coatings has a thickness of about 43 nm. In one embodiment, the second of the two coatings has a thickness of about 44 nm. In one embodiment, the second of the two coatings has a thickness of about 45 nm. In one embodiment, the second of the two coatings has a thickness of about 46 nm. In one embodiment, the second of the two coatings has a thickness of about 47 nm. In one embodiment, the second of the two coatings has a thickness of about 48 nm. In one embodiment, the second of the two coatings has a thickness of about 49 nm. In one embodiment, the second of the two coatings has a thickness of about 50 nm.

In certain embodiments, including any of the foregoing, the thickness of each coating is about 1 nm to 20 nm. In certain embodiments, including any of the foregoing, the thickness of each coating is about 1 nm to 10 nm. In certain embodiments, including any of the foregoing, the thickness of each coating is about 1 nm to 3 nm.

### Cathode Active Material

In certain embodiments, including any of the foregoing, the cathode active material of the particles is selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1.

In certain embodiments, including any of the foregoing, the cathode active material of the particles is selected from MnO, LiₓMn₂O₄, LixMnO₂, LiₓNiO₂, LiₓCoO₂, LiNi_{(1-y)}Co_{y}O₂, LiMn_{y}Co_{(1-y)}O₂, LiₓMn_{(2-y)}Ni_{y}O₄, LiₓFePO₄, LiₓFe_{(1-y)}Mn_{y}PO₄, Liₓ CoPO₄, Li₇V₂(PO₄)₃, Fe₂(SO₄)₃, V₂O₅, or a combination thereof, wherein 1≤x≤5 and 0≤y≤1.

In certain embodiments, including any of the foregoing, the cathode active material is selected from lithium cobalt oxide (LCO), lithium nickel cobalt aluminum oxide (NCA), lithium nickel manganese cobalt oxide (NMC), lithium iron phosphate (LFP), and combinations thereof.

In certain embodiments, including any of the foregoing, the cathode active material is a member of the NMC class of cathode active materials, for example, LiNiCoMnO₂. In certain embodiments, including any of the foregoing, the cathode active material is a member of the LFP class of cathode active materials, for example, LiFePO₄/C. In certain embodiments, including any of the foregoing, the cathode active material is a member of the LNMO class of cathode active materials, for example, LiNi_{0.5}Mn_{1.5}O₄ or LiNi_{0.5}Mn_{1.5}O₂. In certain embodiments, including any of the foregoing, the cathode active material is a member of the NCA class of cathode active materials, for example, LiMn₂O₄. In certain embodiments, including any of the foregoing, the cathode active material is a member of the LMO class of cathode active materials, for example, LiMn₂O₄. In certain embodiments, including any of the foregoing, the cathode active material is a member of the LCO class of cathode active materials, for example, LiCoO₂. In one embodiment, the cathode active material is LiNiO₂. In one embodiment, the cathode active material is LiNi₁₋ₓCoₓO₂ (0.2≤x≤0.5). The cathode active material can be any useful known cathode that is similar to the cathode active materials described herein, even if the molar ratio of the composition changes. For example, the cathode active material can be any cathode active material described in Minnmann et al. Advanced Energy Materials, 2022, 12, 2201425.

In certain embodiments, including any of the foregoing, the cathode active material is selected from LiMPO₄ (M=Fe, Ni, Co, Mn), LiₓTi_{y}O_{z}, wherein x is from 0 to 8, y is from 1 to 12, z is from 1 to 24, LiMn₂O₄, LiMn₂ₐNiₐO₄, wherein a is from 0 to 2, LiCoO₂, Li(NiCoMn)O₂, Li(NiCoAl)O₂, or a nickel cobalt aluminum oxide.

In certain embodiments, including any of the foregoing, the cathode active material is selected from MnO, LiₓMn₂O₄, LiₓMnO₂, LiₓNiO₂, LiₓCoO₂, LiNi_{(1-y)}Co_{y}O₂, LiMn_{y}Co_{(1-y)}O₂, LiₓMn_{(2-y)}Ni_{y}O₄, LiₓFePO₄, LiₓFe_{(1-y)}Mn_{y}PO₄, Liₓ CoPO₄, Li₇V₂(PO₄)₃, Fe₂(SO₄)₃, V₂O₅, or a combination thereof, wherein 1≤x≤5 and 0≤y≤1.

In certain embodiments, including any of the foregoing, the cathode active material is selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; or LiNiₓCo_{y}Al_{z}O₂, wherein x+y+z=1, and 0≤x≤1, 0≤y≤1, and 0≤z≤1.

In certain embodiments, including any of the foregoing, the cathode active material is LiNiₓMn_{y}Co_{z}O₂, x+y+z=1, 0≤x≤1, 0≤y≤l, and 0≤z≤1. In one embodiment, the cathode active material is LiNixMnyCo_{z}O₂, x is 0.8, y is 0.1, and z is 0.1. In certain other examples, the coated cathode active material is LiNixMnyCo_{z}O₂, x is 0.6, y is 0.2, and z is 0.2. In one embodiment, the coated cathode active material is LiNiₓMn_{y}Co_{z}O₂, x is 0.5, y is 0.3, and z is 0.2. In some other examples, the coated cathode active material is LiNiₓMn_{y}Co_{z}O₂, x is 1/3, y is 1/3, and z is 1/3. In certain embodiments, the coated cathode active material is selected from LiMn₂O₄, LiCoO₂, Li(NiCoMn)O₂, or Li(NiCoAl)O₂.

In one embodiment, including any of the foregoing, the cathode active material is LiNiₓMn_{y}Co_{z}O₂, x+y+z=1, 0≤x≤1, 0≤y≤1, and 0≤z≤1. In certain examples, the amount of lithium in the cathode active material will vary depending on the state-of-charge of the battery. For example, the amount of lithium may range from Li_{0.95-1-1}(NiₓMn_{y}Co_{z})O₂, wherein x, y, and z, are as defined above. In certain other examples, the amount of lithium may range from Li_{0.2-1-1}(NiₓMn_{y}Co_{z})O₂, wherein x, y, and z, are as defined above. Other ranges of lithium are contemplated herein.

In certain embodiments, including any of the foregoing, the cathode active material is LiNiₓMn_{y}Co_{z}O₂, x+y+z=1, 0.80≤x≤0.97, 0≤y≤0.2, and 0≤z≤0.2. In certain embodiments, including any of the foregoing, the cathode active material is LiNiₓMn_{y}Co_{z}O₂, x+y+z=1, 0.80≤x≤0.95, 0≤y≤0.2, and 0≤z≤0.2. In certain embodiments, including any of the foregoing, the cathode active material is LiNiₓMn_{y}Co_{z}O₂, x+y+z=1, 0.80≤x≤0.9, 0≤y≤0.2, and 0≤z≤0.2. In certain embodiments, including any of the foregoing, the cathode active material is LiNiₓMn_{y}Co_{z}O₂, x+y+z=1, 0.80≤x≤0.85, 0≤y≤0.2, and 0≤z≤0.2. In certain embodiments, including any of the foregoing, the cathode active material is LiNiₓMn_{y}Co_{z}O₂, x+y+z=1, 0.80≤x≤0.83, 0≤y≤0.2, and 0≤z≤0.2. In one embodiment, the cathode active material has high nickel content, for example, LiNiₓMn_{y}Co_{z}O₂, x+y+z=1, 0.80≤x≤0.97, 0≤y≤0.2, and 0≤z≤0.2. In one embodiment, the cathode active material is LiNiₓMn_{y}Co_{z}O₂, x+y+z=1, 0.80≤x≤0.90, 0≤y≤0.2, and 0≤z≤0.2.

In some embodiments, the cathode active material comprises particles with a diameter of about 1 μm to 20 μm as measured by Transmission Electron Microscopy (TEM). In some embodiments, the cathode active material comprises particles with a diameter of about 1 μm to 15 μm as measured by TEM. In some embodiments, the cathode active material comprises particles with a diameter of about 1 μm to 10 μm as measured by TEM. In some embodiments, the cathode active material comprises particles with a diameter of about 1 μm to 9 μm as measured by TEM. In some embodiments, the cathode active material comprises particles with a diameter of about 1 μm to 8 μm as measured by TEM. In some embodiments, the cathode active material comprises particles with a diameter of about 2 μm to 7 μm as measured by TEM. In some embodiments, the cathode active material comprises particles with a diameter of about 2 μm to 5 μm as measured by TEM.

In some embodiments, the cathode active material is LiNiₓMn_{y}Co_{z}O₂, x+y+z=1, 0≤x≤1, 0≤y≤1, and 0≤z≤1 and comprises particles with a diameter of about 1 μm to 20 μm as measured by TEM. In some embodiments, the cathode active material is LiNiₓMn_{y}Co_{z}O₂, x+y+z=1, 0≤x≤1, 0≤y≤1, and 0≤z≤1 and comprises particles with a diameter of about 1 μm to 15 μm as measured by TEM. In some embodiments, the cathode active material is LiNiₓMn_{y}Co_{z}O₂, x+y+z=1, 0≤x≤1, 0≤y≤1, and 0≤z≤1 and comprises particles with a diameter of about 1 μm to 10 μm as measured by TEM. In some embodiments, the cathode active material is LiNiₓMn_{y}Co_{z}O₂, x+y+z=1, 0≤x≤1, 0≤y≤1, and 0≤z≤1 and comprises particles with a diameter of about 1 μm to 9 μm as measured by TEM. In some embodiments, the cathode active material is LiNiₓMn_{y}Co_{z}O₂, x+y+z=1, 0≤x≤1, 0≤y≤1, and 0≤z≤1 and comprises particles with a diameter of about 1 μm to 8 μm as measured by TEM. In some embodiments, the cathode active material is LiNiₓMn_{y}Co_{z}O₂, x+y+z=1, 0≤x≤1, 0≤y≤1, and 0≤z≤1 and comprises particles with a diameter of about 2 μm to 7 μm as measured by TEM. In some embodiments, the cathode active material is LiNiₓMn_{y}Co_{z}O₂, x+y+z=1, 0≤x≤1, 0≤y≤1, and 0≤z≤1 and comprises particles with a diameter of about 2 μm to 5 μm as measured by TEM.

In some embodiments, the cathode active material is LiNiₓMn_{y}Co_{z}O₂, x+y+z=1, 0.80≤x≤1, 0≤y≤1, and 0≤z≤1, wherein x+y+z=1 and comprises particles with a diameter of about 1 μm to 20 μm as measured by TEM. In some embodiments, the cathode active material is LiNiₓMn_{y}Co_{z}O₂, x+y+z=1, 0.80≤x≤1, 0≤y≤1, and 0≤z≤1, wherein x+y+z=1 and comprises particles with a diameter of about 1 μm to 15 μm as measured by TEM. In some embodiments, the cathode active material is LiNiₓMn_{y}Co_{z}O₂, x+y+z=1, 0.80≤x≤1, 0≤y≤1, and 0≤z≤1, wherein x+y+z=1 and comprises particles with a diameter of about 1 μm to 10 μm as measured by TEM. In some embodiments, the cathode active material is LiNiₓMn_{y}Co_{z}O₂, x+y+z=1, 0.80≤x≤1, 0≤y≤1, and 0≤z≤1, wherein x+y+z=1 and comprises particles with a diameter of about 1 μm to 9 μm as measured by TEM. In some embodiments, the cathode active material is LiNiₓMn_{y}Co_{z}O₂, x+y+z=1, 0.80≤x≤1, 0≤y≤1, and 0≤z≤1, wherein x+y+z=1 and comprises particles with a diameter of about 1 μm to 8 μm as measured by TEM. In some embodiments, the cathode active material is LiNiₓMn_{y}Co_{z}O₂, x+y+z=1, 0.80≤x≤1, 0≤y≤1, and 0≤z≤1, wherein x+y+z=1 and comprises particles with a diameter of about 2 μm to 7 μm as measured by TEM. In some embodiments, the cathode active material is LiNiₓMn_{y}Co_{z}O₂, x+y+z=1, 0.80≤x≤1, 0≤y≤1, and 0≤z≤1, wherein x+y+z=1 and comprises particles with a diameter of about 2 μm to 5 μm as measured by TEM.

In some embodiments, the cathode active material is LiNiₓMn_{y}Co_{z}O₂, x+y+z=1, 0.80≤x≤0.90, 0≤y≤0.2, and 0≤z≤0.2, wherein x+y+z=1 and comprises particles with a diameter of about 1 μm to 20 μm as measured by TEM. In some embodiments, the cathode active material is LiNiₓMn_{y}Co_{z}O₂, x+y+z=1, 0.80≤x≤0.90, 0≤y≤0.2, and 0≤z≤0.2, wherein x+y+z=1 and comprises particles with a diameter of about 1 μm to 15 μm as measured by TEM. In some embodiments, the cathode active material is LiNiₓMn_{y}Co_{z}O₂, x+y+z=1, 0.80≤x≤0.90, 0≤y≤0.2, and 0≤z≤0.2, wherein x+y+z=1 and comprises particles with a diameter of about 1 μm to 10 μm as measured by TEM. In some embodiments, the cathode active material is LiNiₓMn_{y}Co_{z}O₂, x+y+z=1, 0.80≤x≤0.90, 0≤y≤0.2, and 0≤z≤0.2, wherein x+y+z=1 and comprises particles with a diameter of about 1 μm to 9 μm as measured by TEM. In some embodiments, the cathode active material is LiNiₓMn_{y}Co_{z}O₂, x+y+z=1, 0.80≤x≤0.90, 0≤y≤0.2, and 0≤z≤0.2, wherein x+y+z=1 and comprises particles with a diameter of about 1 μm to 8 μm as measured by TEM. In some embodiments, the cathode active material is LiNiₓMn_{y}Co_{z}O₂, x+y+z=1, 0.80≤x≤0.90, 0≤y≤0.2, and 0≤z≤0.2, wherein x+y+z=1 and comprises particles with a diameter of about 2 μm to 7 μm as measured by TEM. In some embodiments, the cathode active material is LiNiₓMn_{y}Co_{z}O₂, x+y+z=1, 0.80≤x≤0.90, 0≤y≤0.2, and 0≤z≤0.2, wherein x+y+z=1 and comprises particles with a diameter of about 2 μm to 5 μm as measured by TEM.

As set forth herein, is a composition comprising: 1) a cathode active material selected from lithium cobalt oxide (LCO), lithium nickel cobalt aluminum oxide (NCA), lithium nickel manganese cobalt oxide (NMC), lithium iron phosphate (LFP), or combinations thereof; and 2) a coating in contact with the cathode active material wherein the coating comprises a lithium phosphate species and wherein at least about 60% of the surface of the cathode active material is in contact with the coating.

As set forth herein, is a composition comprising: 1) a cathode active material selected from lithium cobalt oxide (LCO), lithium nickel cobalt aluminum oxide (NCA), lithium nickel manganese cobalt oxide (NMC), lithium iron phosphate (LFP), and combinations thereof; and 2) a coating in contact with the cathode active material wherein the coating comprises a lithium phosphate species and wherein the lithium phosphate species is a reaction product of LiOEt and a phosphorus precursor wherein the molar ratio of Li:P in the reaction mixture is about 3:1 to 1:3 and wherein the lithium phosphate species is a product of heat treatment from about 250° C. to 375° C. In some embodiments, the molar ratio of Li:P in the reaction mixture is about 3:1 to 3:3.

In one embodiment, including any of the foregoing, the cathode active material is LiNiₓMn_{y}Co_{z}O₂, x+y+z=1, 0≤x≤1, 0≤y≤1, and 0≤z≤1. In one embodiment, including any of the foregoing, the cathode active material is LiNiₓMn_{y}Co_{z}O₂, x is 0.8, y is 0.1, and z is 0.1. In one embodiment, including any of the foregoing, the cathode active material is LiNiₓMn_{y}Co_{z}O₂, x is 0.6, y is 0.2, and z is 0.2. In one embodiment, including any of the foregoing, the cathode active material is LiNiₓMn_{y}Co_{z}O₂, x is 0.5, y is 0.3, and z is 0.2. In one embodiment, including any of the foregoing, the cathode active material is LiNiₓMn_{y}Co_{z}O₂, x is 1/3, y is 1/3, and z is 1/3. In one embodiment, including any of the foregoing, the cathode active material is LiNiₓMn_{y}Co_{z}O₂, x+y+z=1, 0.80≤x≤0.97, 0≤y≤0.2, and 0≤z≤0.2. In one embodiment, including any of the foregoing, the cathode active material is LiNiₓMn_{y}Co_{z}O₂, x+y+z=1, 0.80≤x≤0.95, 0≤y≤0.2, and 0≤z≤0.2. In one embodiment, including any of the foregoing, the cathode active material is LiNiₓMn_{y}Co_{z}O₂, x+y+z=1, 0.80≤x≤0.9, 0≤y≤0.2, and 0≤z≤0.2. In one embodiment, including any of the foregoing, the cathode active material is LiNiₓMn_{y}Co_{z}O₂, x+y+z=1, 0.80≤x≤0.85, 0≤y≤0.2, and 0≤z≤0.2. In one embodiment, including any of the foregoing, the cathode active material is LiNiₓMn_{y}Co_{z}O₂, x+y+z=1, 0.80≤x≤0.83, 0≤y≤0.2, and 0≤z≤0.2.

Also set forth herein is also a solid-state battery comprising 1) cathode active material particles selected from LiMPO₄ (M=Fe, Ni, Co, Mn); LixTiyOz, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1; 2) a coating in contact with the cathode active material particles wherein the coating comprises a lithium phosphate species and wherein at least about 60% of the surface area of the cathode active material particles is in contact with the coating; 3) a solid-state electrolyte; and, 4) an anode active material selected from lithium metal, lithium titanate (Li₂TiO₃, LTO), carbon/graphite (C), silicon (Si)/silicon oxide (SiOₓ), lithium (Li), zinc (Zn), aluminum (Al), magnesium (Mg), alloys thereof, and combinations thereof.

Also set forth herein is also a solid-state battery comprising 1) cathode active material particles selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; or LiNiₓCo_{y}Al_{z}O₂, wherein x+y+z=1, and 0≤x≤1, 0≤y≤1, and 0≤z≤1; 2) a coating in contact with the cathode active material particles wherein the coating comprises a lithium phosphate species and wherein the lithium phosphate species is a reaction product of LiOEt and a phosphorus precursor wherein the molar ratio of Li:P in the reaction mixture is about 3:1 to 1:3 and wherein the lithium phosphate species is a product of heating at a temperature from about 250° C. to 375° C.; 3) a solid-state electrolyte; and, 4) an anode active material selected from lithium metal, lithium titanate (Li₂TiO₃, LTO), carbon/graphite (C), silicon (Si)/silicon oxide (SiOₓ), lithium (Li), zinc (Zn), aluminum (Al), magnesium (Mg), alloys thereof, and combinations thereof. In some embodiments, the molar ratio of Li:P in the reaction mixture is about 3:1 to 3:3.

In certain embodiments, including any of the foregoing, the cathode active material of the particles in the battery is selected from LiMPO₄ (M=Fe, Ni, Co, Mn), LiₓTi_{y}O_{z}, wherein x is from 0 to 8, y is from 1 to 12, z is from 1 to 24, LiMn₂O₄, LiMn₂ₐNiₐO₄, wherein a is from 0 to 2, LiCoO₂, Li(NiCoMn)O₂, Li(NiCoAl)O₂, or a nickel cobalt aluminum oxide.

In certain embodiments, including any of the foregoing, the cathode active material in the battery is selected from LiMPO₄ (M=Fe, Ni, Co, Mn), LiₓTi_{y}O_{z}, wherein x is from 0 to 8, y is from 1 to 12, z is from 1 to 24, LiMn₂ₐNiₐO₄, wherein a is from 0 to 2, or nickel cobalt aluminum oxides.

In certain embodiments, including any of the foregoing, the cathode active material of the particles in the battery is selected from MnO, LiₓMn₂O₄, LiₓMnO₂, LiₓNiO₂, LiₓCoO₂, LiNi_{(1-y)}Co_{y}O₂, LiMn_{y}Co_{(1-y)}O₂, LiₓMn_{(2-y)}Ni_{y}O₄, LiₓFePO₄, LiₓFe_{(1-y)}Mn_{y}PO₄, Liₓ CoPO₄, Li₇V₂(PO₄)₃, Fe₂(SO₄)₃, V₂O₅, or a combination thereof, wherein 1≤x≤5 and 0≤y≤1.

In certain embodiments, including any of the foregoing, the cathode active material in the battery is selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; or LiNiₓCo_{y}Al_{z}O₂, wherein x+y+z=1, and 0≤x≤1, 0≤y≤1, and 0≤z≤1. In certain embodiments, including any of the foregoing, the cathode active material is LiNiₓMn_{y}Co_{z}O₂, x+y+z=1, 0≤x≤1, 0≤y≤1, and 0≤z≤1. In certain examples, the cathode active material is LiNiₓMn_{y}Co_{z}O₂, x is 0.8, y is 0.1, and z is 0.1. In certain other examples, the coated cathode active material is LiNiₓMn_{y}Co_{z}O₂, x is 0.6, y is 0.2, and z is 0.2. In some other examples, the coated cathode active material is LiNiₓMn_{y}Co_{z}O₂, x is 0.5, y is 0.3, and z is 0.2. In other examples, the coated cathode active material is LiNiₓMn_{y}Co_{z}O₂, x is 1/3, y is 1/3, and z is 1/3. In certain embodiments, the coated cathode active material is selected from LiMn₂O₄, LiCoO₂, Li(NiCoMn)O₂, and Li(NiCoAl)O₂.

In certain embodiments, including any of the foregoing, the cathode active material in the battery is selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; or LiNixCoyAl_{z}O₂, wherein x+y+z=1, and 0≤x≤1, 0≤y≤1, and 0≤z≤1.

In certain embodiments, including any of the foregoing, the cathode active material in the battery is selected from MnO, LiₓMn₂O₄, LiₓMnO₂, LiₓNiO₂, LiₓCoO₂, LiNi_{(1-y)}Co_{y}O₂, LiMn_{y}Co_{(1-y)}O₂, LiₓMn_{(2-y)}Ni_{y}O₄, LiₓFePO₄, LiₓFe_{(1-y)}Mn_{y}PO₄, Liₓ CoPO₄, Li₇V₂(PO₄)₃, Fe₂(SO₄)₃, V₂O₅, or a combination thereof, wherein 1≤x≤5 and 0≤y≤1.

In one embodiment, including any of the foregoing, the cathode active material in the battery is LiNiₓMn_{y}Co_{z}O₂, x+y+z=1, 0≤x≤1, 0≤y≤1, and 0≤z≤1. In one embodiment, including any of the foregoing, the cathode active material in the battery is LiNiₓMn_{y}Co_{z}O₂, x is 0.8, y is 0.1, and z is 0.1. In one embodiment, including any of the foregoing, the cathode active material in the battery is LiNiₓMn_{y}Co_{z}O₂, x is 0.6, y is 0.2, and z is 0.2. In one embodiment, including any of the foregoing, the cathode active material in the battery is LiNiₓMn_{y}Co_{z}O₂, x is 0.5, y is 0.3, and z is 0.2. In certain embodiments, including any of the foregoing, the cathode active material in the battery is LiNiₓMn_{y}Co_{z}O₂, x+y+z=1, 0.80≤x≤0.97, 0≤y≤0.2, and 0≤z≤0.2. In certain embodiments, including any of the foregoing, the cathode active material in the battery is LiNiₓMn_{y}Co_{z}O₂, x+y+z=1, 0.80≤x≤0.95, 0≤y≤0.2, and 0≤z≤0.2. In certain embodiments, including any of the foregoing, the cathode active material in the battery is LiNiₓMn_{y}Co_{z}O₂, x+y+z=1, 0.80≤x≤0.9, 0≤y≤0.2, and 0≤z≤0.2. In certain embodiments, including any of the foregoing, the cathode active material in the battery is LiNiₓMn_{y}Co_{z}O₂, x+y+z=1, 0.80≤x≤0.85, 0≤y≤0.2, and 0≤z≤0.2. In certain embodiments, including any of the foregoing, the cathode active material in the battery is LiNiₓMn_{y}Co_{z}O₂, x+y+z=1, 0.80≤x≤0.83, 0≤y≤0.2, and 0≤z≤0.2.

In certain embodiments, including any of the foregoing, the cathode active material is a member of the NMC class of cathode active materials, for example, LiNiCoMnO₂. In certain embodiments, including any of the foregoing, the cathode active material is a member of the LFP class of cathode active materials, for example, LiFePO₄/C. In certain embodiments, including any of the foregoing, the cathode active material is a member of the LNMO class of cathode active materials, for example, LiNi_{0.5}Mn_{1.5}O₄ or LiNi_{0.5}Mn_{1.5}O₂. In certain embodiments, including any of the foregoing, the cathode active material is a member of the NCA class of cathode active materials, for example, LiMn₂O₄. In certain embodiments, including any of the foregoing, the cathode active material is a member of the LMO class of cathode active materials, for example, LiMn₂O₄. In certain embodiments, including any of the foregoing, the cathode active material is a member of the LCO class of cathode active materials, for example, LiCoO₂.

In some other embodiments, the cathode active material is, or includes, a manganese oxide (MnO), iron oxides, copper oxides, nickel oxides, lithium-manganese complex oxides (e.g., LiₓMn₂O₄ or LixMnO₂), lithium-nickel complex oxides (e.g., LiₓNiO₂), lithium-cobalt complex oxides (e.g. LiXCoO₂), lithium cobalt nickel oxides (LiNi_{1-y}Co_{y}O₂), lithium-manganese-cobalt complex oxides (e.g., LiMn_{y}Co_{1-y}O₂), spinel-phase lithium-manganese-nickel complex oxides (e.g., LiₓMn_{2-y}Ni_{y}O₄), lithium phosphates having an olivine structure (e.g., LiₓFePO₄, LiₓFe_{1-y}Mn_{y}PO₄, LiXCoPO₄), lithium phosphates having a NASICON-type structure (e.g., Li₇V₂(PO₄)₃), iron (III) sulfate (Fe₂(SO₄)₃), or vanadium oxides (e.g., V₂O₅). In some embodiments, x and y in these chemical formulas lie within the ranges of 1≤x≤5, and 0≤y≤1. In some embodiments, the cathode active material is LiCoO₂, LixV₂(PO₄)₃, LiNiPO₄, and LiFePO₄. In some embodiments, the cathode active material is doped LiCoO₂, including La-doped LiCoO₂, Al-doped LiCoO₂, or a combination thereof

In some embodiments, including any of the foregoing, the cathode active material is LiNiₓMn_{y}Co_{z}O₂, x+y+z=1, 0.8≤x≤1, 0≤y≤1, and 0≤z≤1 and wherein x+y+z=1.

In some embodiments, including any of the foregoing, the cathode active material is LiNiₓMn_{y}Co_{z}O₂ and either (a)-(e) wherein x, y, and z sum to 1:
(a) x is 0.8, y is 0.1, and z is 0.1;
(b) 0.80≤x≤0.97, 0≤y≤0.2, and 0≤z≤0.2;
(c) 0.80≤x≤0.90, 0≤y≤0.2, and 0≤z≤0.2;
(d) 0.80≤x≤0.85, 0≤y≤0.2, and 0≤z≤0.2; or
(e) 0.80≤x≤0.83, 0≤y≤0.2, and 0≤z≤0.2.

In one embodiment, including any of the foregoing, the cathode active material in the battery is LiNiₓMn_{y}Co_{z}O₂, x is 1/3, y is 1/3, and z is 1/3.

In one embodiment, including any of the foregoing, the cathode active material in the battery is selected from LiMn₂O₄, LiCoO₂, Li(NiCoMn)O₂, or Li(NiCoAl)O₂.

In one embodiment, including any of the foregoing, the cathode active material is selected from LiMn₂O₄, LiCoO₂, Li(NiCoMn)O₂, or Li(NiCoAl)O₂.

In one embodiment, including any of the foregoing, the cathode active material is Li(NiCoMn)O₂.

In some embodiments, the cathode active material is doped with zirconium. In some embodiments, the cathode active material is Zr-doped LiNiₓMn_{y}Co_{z}O₂, x+y+z=1, 0.8≤x≤1, 0≤y≤1, and 0≤z≤1, wherein x+y+z=1. In some embodiments, the cathode active material is Zr-doped LiNiₓMn_{y}Co_{z}O₂, x+y+z=1, 0.80≤x≤0.90, 0≤y≤0.2, and 0≤z≤0.2, wherein x+y+z=1.

Unless explicitly stated otherwise, the variables herein are chosen so that the chemical formula is charge neutral.

In some other examples, set forth herein is a battery comprising a solid-state cathode set forth herein, a solid separator and an anode.

In certain embodiments, set forth herein is a solid-state cathode comprising a coated cathode active material set forth herein.

In certain embodiments, including any of the foregoing, the solid-state cathode comprises a solid-state electrolyte selected from the group consisting of Li₂S—SiS₂, Li₂S SiS₂—LiI, Li₂S—SiS₂-Li₃MO₄, Li₂S—SiS₂-Li₃MO₃, Li₂S—P₂S₅—LiI, and LATS, where M is a member selected from the group consisting of Si, P, Ge, B, Al, Ga, and In.

In certain embodiments, including any of the foregoing, the solid-state cathode comprises a catholyte as described in International Patent Application Publication No. WO2023121838A1, CATHOLYTES FOR A SOLID-STATE BATTERY, filed Nov. 11, 2022, as PCT/US22/51433, which is incorporated by reference herein in its entirety.

In certain embodiments, the catholyte includes: a lithium salt; and at least two C₃₋₁₀ heterocyclic molecules, each independently, in each instance, including at least one sulfur (S) ring atom and optionally substituted with 1 to 6 substituents.

In some embodiments, including any of the foregoing, the C₃₋₁₀ heterocyclic molecules is a molecule of Formula

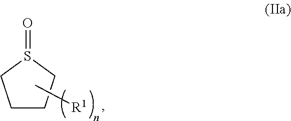

wherein R¹ is selected from the group consisting of polyethylene glycol (PEG), ═O, SO₂, —CF₃, —CH₂F, CHF₂, —NO₂, —NO₃, —NH₃, —CH₃, PO₄, PO₃, BO₃, —CN, and combinations thereof, and subscript n is an integer from 0 to 8.

In some embodiments, including any of the foregoing, the C₃₋₁₀ heterocyclic molecules are a molecule of Formula (III):

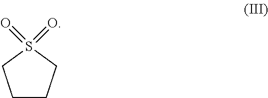

In some embodiments, including any of the foregoing, the C₃₋₁₀ heterocyclic molecule comprises at least one sulfur (S) ring atom.

In some embodiments, including any of the foregoing, the C₃₋₁₀ heterocyclic molecule comprises at least one sulfur (S) ring atom and one oxygen (O) ring atom.

In some embodiments, including any of the foregoing, at least one C₃₋₁₀ heterocyclic molecule is selected from the group consisting of ethylene sulfite, sulfolane; and combinations thereof. In some embodiments, including any of the foregoing, at least one C₃₋₁₀ heterocyclic molecule is selected from ethylene sulfite. In some embodiments, including any of the foregoing, at least one C₃₋₁₀ heterocyclic molecule is selected from sulfolane.

In some embodiments, including any of the foregoing, the lithium salt is selected from the group consisting of LiPF₆, Lithium bis(oxalato)borate (LiBOB), lithium bis(perfluoroethanesulfonyl)imide (LIBETI), bis(trifluoromethane)sulfonimide (LiTFSI), LiBF₄, LiClO₄, LiAsF₆, lithium bis(fluorosulfonyl)imide (LiFSI), LiF, LiCl, LiBr, LiI, and combinations thereof.

In some embodiments, including any of the foregoing, the lithium salt is present at a concentration of about 0.5 M to about 5.0 M. In some embodiments, including any of the foregoing, the lithium salt is present at a concentration of about 0.5 M to about 2.5 M. In some other embodiments, including any of the foregoing, the lithium salt is present at a concentration of about 0.5 M to about 2.0 M.

In some embodiments, including any of the foregoing, the catholyte includes two C₃₋₁₀ heterocyclic molecules, wherein a ratio of one C₃₋₁₀ heterocyclic molecule to the other C₃₋₁₀ heterocyclic molecules is from 20:80 vol/vol (v/v) to 80:20 v/v. In some embodiments, including any of the foregoing, the ratio of one C₃₋₁₀ heterocyclic molecule to the other C₃₋₁₀ heterocyclic molecules is from 15:85 vol/vol (v/v) to 85:15 v/v. In some embodiments, including any of the foregoing, the ratio of one C₃₋₁₀ heterocyclic molecule to the other C₃₋₁₀ heterocyclic molecules is from 20:80 vol/vol (v/v) to 80:20 v/v. In some embodiments, including any of the foregoing, the ratio of one C₃₋₁₀ heterocyclic molecule to the other C₃₋₁₀ heterocyclic molecules is from 25:75 vol/vol (v/v) to 75:25 v/v. In some embodiments, including any of the foregoing, the ratio of one C₃₋₁₀ heterocyclic molecule to the other C₃₋₁₀ heterocyclic molecules is from 30:70 vol/vol (v/v) to 70:30 v/v. In some embodiments, including any of the foregoing, the ratio of one C₃₋₁₀ heterocyclic molecule to the other C₃₋₁₀ heterocyclic molecules is from 35:65 vol/vol (v/v) to 65:35 v/v. In some embodiments, including any of the foregoing, the ratio of one C₃₋₁₀ heterocyclic molecule to the other C₃₋₁₀ heterocyclic molecules is from 40:60 vol/vol (v/v) to 60:40 v/v. In some embodiments, including any of the foregoing, the ratio of one C₃₋₁₀ heterocyclic molecule to the other C₃₋₁₀ heterocyclic molecules is from 45:55 vol/vol (v/v) to 55:45 v/v. In some embodiments, including any of the foregoing, the ratio of one C₃₋₁₀ heterocyclic molecule to the other C₃₋₁₀ heterocyclic molecules is 50:50 vol/vol (v/v).

In some embodiments, including any of the foregoing, the ratio of sulfolane:(ethylene sulfite) is from 30:70 v/v to 50:50 v/v. In some embodiments, including any of the foregoing, the ratio of sulfolane:(ethylene sulfite) is 30:70 v/v. In some embodiments, including any of the foregoing, the ratio of sulfolane:(ethylene sulfite) is 50:50 v/v. In some embodiments, including any of the foregoing, the ratio of sulfolane:(ethylene sulfite) is from 10:90 v/v to 90:10 v/v. In some embodiments, including any of the foregoing, the ratio of sulfolane:(ethylene sulfite) is from 10:90 v/v to 50:50 v/v.

In some embodiments, including any of the foregoing, the catholyte also includes an additive selected from the group consisting of tris(trimethysilyl) phosphite (TTSPi), tris(trimethysilyl) phosphate (TTSPa), trimethoxyboroxine (C₃H₉B₃O₆, TMOBX), vinylene carbonate (VC), vinyl ethylene carbonate (VEC), methylene methane disulfonate (MMDS), prop-1-ene-1,3 sultone (PES), fluoroethylene carbonate (FEC), LiTFSi, LiBOB, succinonitrile, trimethylene sulfate (TMS), triallyl phosphate (TAP), tris(trimethylsilyl) borate (TMSB), tris(pentafluorophenyl) borane (TPFPB), methyl acetate; tris(trimethylsilyl) acetate; tris(trimethylsilyl) pyridine; tris(trimethylsilyl) methacrylate; tris (2,2,2-trifluoroethyl) phosphite; tris(2,2,2-trifluoroethyl) borate; and combinations thereof.

In some embodiments, including any of the foregoing, the additive is TTSPi. In some embodiments, including any of the foregoing, the additive is TTSPa. In some embodiments, including any of the foregoing, the additive is a combination of TTSPi and TTSPa.

In some embodiments, the catholyte is in contact with a solid separator comprising lithium-stuffed garnet. In some embodiments, the solid separator is a thin film. PROCESS FOR MAKING

Set forth herein is a process for making cathode active material particles coated with a lithium phosphate species, the process comprising: 1) coating cathode active material particles with a reaction mixture comprising a lithium precursor, a phosphorus precursor, and a solvent, wherein the molar ratio of Li:P in the reaction mixture is about 3:1 to 1:3; 2) removing the solvent from the reaction mixture; and 3) heating the cathode active material particles at a temperature from about 150° C. to 375° C., under dry air conditions or an O₂ atmosphere, to form cathode active material particles coated with a lithium phosphate species.

Set forth herein is a process for making lithium phosphate species-coated cathode active material particles comprising the following steps: 1) coating cathode active material particles with a solution of a) a lithium precursor and b) a phosphorus precursor wherein the molar ratio of Li:P in the reaction mixture is about 3:1 to 1:3; 2) removing the solvent from the solution to provide lithium phosphate species-coated cathode active material particles; and, 3) heating the cathode active material particles under dry air conditions or an O₂ atmosphere at a temperature from about 150° C. to 375° C. to form lithium phosphate species-coated cathode active material particles.

In some embodiments, the temperature is from about 150° C. to 350° C. In some embodiments, the temperature is from about 150° C. to 300° C. In some embodiments, the temperature is from about 150° C. to 250° C. In some embodiments, the temperature is from about 250° C. to 375° C. In some embodiments, the temperature is from about 350° C. to 375° C. In some embodiments, the temperature is from about 300° C. to 350° C. In some embodiments, the temperature is from about 250° C. to 300° C. In some embodiments, the temperature is about 375° C. In some embodiments, the temperature is about 350° C. In some embodiments, the temperature is about 300° C. In some embodiments, the temperature is about 250° C. In some embodiments, the temperature is about 150° C.

In some embodiments, the molar ratio of Li:P in the reaction mixture is about 3:1 to 3:3. In some embodiments, the molar ratio of Li:P in the reaction mixture is about 3:1. In some embodiments, the molar ratio of Li:P in the reaction mixture is about 3:1.5. In some embodiments, the molar ratio of Li:P in the reaction mixture is about 3:2. In some embodiments, the molar ratio of Li:P in the reaction mixture is about 1:3. In some embodiments, the molar ratio of Li:P in the reaction mixture is about 2:3.

In some embodiments, the heating is done in a controlled atmosphere. In some embodiments, that controlled atmosphere comprises O₂, Ar, N₂, H₂, H₂O, or combinations thereof. In some embodiments, that controlled atmosphere comprises an O₂ atmosphere.

In some embodiments, the lithium phosphate species comprises a compound of the formula LiₓP_{y}O_{z}, wherein 1.0≤x≤4.0, 0≤y≤2.0, and 2.0≤z≤7.0, and wherein the formula is charge neutral. In some embodiments, the lithium phosphate species comprises a compound of the formula LiₓP_{y}O_{z}, wherein 0.6≤x≤1.5, 0.5≤y≤1.4, and 2.0≤z≤3.7, and wherein the formula is charge neutral.

In some embodiments, the lithium phosphate species is Li₃PO₄, LiPO₃, Li₄P₂O₇, a mixture of Li₄P₂O₇ and Li₃PO₄ (i.e., Li₄P₂O₇/Li₃PO₄), a mixture of Li₄P₂O₇ and LiPO₃ (i.e., Li₄P₂O₇/LiPO₃), a lithium organophosphate, or combinations thereof. In some embodiments, the lithium phosphate species is Li₃PO₄. In some embodiments, the lithium phosphate species is LiPO₃. In some embodiments, the lithium phosphate species is Li₄P₂O₇/Li₃PO₄. In some embodiments, the lithium phosphate species is Li₄P₂O₇/LiPO₃. In some embodiments, the lithium phosphate species is a lithium organophosphate. In some embodiments, the lithium organophosphate is lithium diethylphosphate, lithium dimethylphosphate, lithium diisopropylphosphate, lithium ethyl methyl phosphate, lithium ethyl isopropyl phosphate, lithium methyl isopropyl phosphate, dilithium methylphosphate, dilithium ethylphosphate, dilithium isopropylphosphate or combinations thereof.

In some embodiments, the lithium phosphate species is crystalline, amorphous, or combinations thereof. In some embodiments, the lithium phosphate species is crystalline. In some embodiments, the lithium phosphate species is amorphous. In some embodiments, the lithium phosphate species is crystalline and amorphous.

In some embodiments, the lithium phosphate species is crystalline Li₃PO₄. In some embodiments, the lithium phosphate species is amorphous Li₃PO₄. In some embodiments, the lithium phosphate species is crystalline Li₃PO₄ and amorphous Li₃PO₄. In some embodiments, the lithium phosphate species is crystalline LiPO₃. In some embodiments, the lithium phosphate species is amorphous LiPO₃. In some embodiments, the lithium phosphate species is crystalline LiPO₃ and amorphous LiPO₃. In some embodiments, the lithium phosphate species is crystalline Li₄P₂O₇. In some embodiments, the lithium phosphate species is amorphous Li₄P₂O₇. In some embodiments, the lithium phosphate species is crystalline Li₄P₂O₇ and amorphous Li₄P₂O₇. In some embodiments, the lithium phosphate species is a mixture of crystalline Li₄P₂O₇ and crystalline Li₃PO₄ (i.e., crystalline Li₄P₂O₇/Li₃PO₄). In some embodiments, the lithium phosphate species is a mixture of amorphous Li₄P₂O₇ and amorphous Li₃PO₄ (i.e., amorphous Li₄P₂O₇/Li₃PO₄). In some embodiments, the lithium phosphate species is a mixture of crystalline Li₄P₂O₇/Li₃PO₄ and amorphous Li₄P₂O₇/Li₃PO₄. In some embodiments, the lithium phosphate species is crystalline Li₄P₂O₇/LiPO₃. In some embodiments, the lithium phosphate species is amorphous Li₄P₂O₇/LiPO₃. In some embodiments, the lithium phosphate species is crystalline Li₄P₂O₇/LiPO₃ and amorphous Li₄P₂O₇/LiPO₃.

In some embodiments, the phosphorus precursor is selected from P₂O₅, H₃PO₄, (NH₄)₃PO₄, (NH₃)₃PO₄, diethylphosphate, dimethylphosphate and combinations thereof. In some embodiments, the lithium precursor is selected from lithium hydroxide (LiOH) lithium ethoxide (LiOEt), lithium methoxide (LiOMe), metallic lithium, or combinations thereof. In some embodiments, the phosphorus precursor is a sol-gel precursor, such as a phosphorus alkoxide precursor. In some embodiments, the phosphorus precursor is P₂O₅. In some embodiments, the lithium precursor is LiOH. In some embodiments, the lithium precursor is LiOEt.

In some embodiments, the phosphorus precursor is P₂O₅ and the lithium precursor is LiOH. In some embodiments, the phosphorus precursor is P₂O₅ and the lithium precursor is LiOEt.

In some embodiments, a source of LiOH includes, but is not limited to LiOH. In some embodiments, a source of LiOH includes, but is not limited to a lithium-containing compound which is soluble in an alcohol, for example methanol or ethanol.

In some embodiments, the heating is at about 150° C. for at least 10 minutes. In some embodiments, the heating is about 150° C. for at least 30 minutes. In some embodiments, the heating is about 150° C. for about 1 hour. In some embodiments, the heating is about 150° C. for about 1.5 hour. In some embodiments, the heating is about 150° C. for up to 5 hours. In some embodiments, the heating is at about 250° C. for at least 10 minutes. In some embodiments, the heating is about 250° C. for at least 30 minutes. In some embodiments, the heating is about 250° C. for about 1 hour. In some embodiments, the heating is about 250° C. for about 1.5 hour. In some embodiments, the heating is about 250° C. for up to 5 hours. In some embodiments, the heating is at about 300° C. for at least 10 minutes. In some embodiments, the heating is about 300° C. for at least 30 minutes. In some embodiments, the heating is about 300° C. for about 1 hour. In some embodiments, the heating is about 300° C. for about 1.5 hour. In some embodiments, the heating is about 300° C. for up to 5 hours. In some embodiments, the heating is at about 350° C. for at least 10 minutes. In some embodiments, the heating is about 350° C. for at least 30 minutes. In some embodiments, the heating is about 350° C. for about 1 hour. In some embodiments, the heating is about 350° C. for about 1.5 hour. In some embodiments, the heating is about 350° C. for up to 5 hours. In some embodiments, the heating is at about 375° C. for at least 10 minutes. In some embodiments, the heating is about 375° C. for at least 30 minutes. In some embodiments, the heating is about 375° C. for about 1 hour. In some embodiments, the heating is about 375° C. for about 1.5 hour. In some embodiments, the heating is about 375° C. for up to 5 hours.

In some embodiments, the solvent is an alcohol, including but not limited to, methanol or ethanol.

In some embodiments, the lithium phosphate species is a reaction product of LiOEt and a phosphorus precursor wherein the molar ratio of Li:P in the reaction mixture is about 3:1 and the lithium phosphate species is a product of heating at about 150° C. In some embodiments, the lithium phosphate species is a reaction product of LiOEt and a phosphorus precursor wherein the molar ratio of Li:P in the reaction mixture is about 3:1 and the lithium phosphate species is a product of heating at about 250° C. In some embodiments, the lithium phosphate species is a reaction product of LiOEt and a phosphorus precursor wherein the molar ratio of Li:P in the reaction mixture is about 3:1 and the lithium phosphate species is a product of heating at about 300° C. In some embodiments, the lithium phosphate species is a reaction product of LiOEt and a phosphorus precursor wherein the molar ratio of Li:P in the reaction mixture is about 3:1 and the lithium phosphate species is a product of heating at about 350° C. In some embodiments, the lithium phosphate species is a reaction product of LiOEt and a phosphorus precursor wherein the molar ratio of Li:P in the reaction mixture is about 3:1 and the lithium phosphate species is a product of heating at about 375° C.

In some embodiments, the lithium phosphate species is a reaction product of LiOEt and a phosphorus precursor wherein the molar ratio of Li:P in the reaction mixture is about 3:1.5 and the lithium phosphate species is a product of heating at about 150° C. In some embodiments, the lithium phosphate species is a reaction product of LiOEt and a phosphorus precursor wherein the molar ratio of Li:P in the reaction mixture is about 3:1.5 and the lithium phosphate species is a product of heating at about 250° C. In some embodiments, the lithium phosphate species is a reaction product of LiOEt and a phosphorus precursor wherein the molar ratio of Li:P in the reaction mixture is about 3:1.5 and the lithium phosphate species is a product of heating at about 300° C. In some embodiments, the lithium phosphate species is a reaction product of LiOEt and a phosphorus precursor wherein the molar ratio of Li:P in the reaction mixture is about 3:1.5 and the lithium phosphate species is a product of heating at about 350° C. In some embodiments, the lithium phosphate species is a reaction product of LiOEt and a phosphorus precursor wherein the molar ratio of Li:P in the reaction mixture is about 3:1.5 and the lithium phosphate species is a product of heating at about 375° C.

In some embodiments, the lithium phosphate species is a reaction product of LiOEt and a phosphorus precursor wherein the molar ratio of Li:P in the reaction mixture is about 3:2 and the lithium phosphate species is a product of heating at about 150° C. In some embodiments, the lithium phosphate species is a reaction product of LiOEt and a phosphorus precursor wherein the molar ratio of Li:P in the reaction mixture is about 3:2 and the lithium phosphate species is a product of heating at about 250° C. In some embodiments, the lithium phosphate species is a reaction product of LiOEt and a phosphorus precursor wherein the molar ratio of Li:P in the reaction mixture is about 3:2 and the lithium phosphate species is a product of heating at about 300° C. In some embodiments, the lithium phosphate species is a reaction product of LiOEt and a phosphorus precursor wherein the molar ratio of Li:P in the reaction mixture is about 3:2 and the lithium phosphate species is a product of heating at about 350° C. In some embodiments, the lithium phosphate species is a reaction product of LiOEt and a phosphorus precursor wherein the molar ratio of Li:P in the reaction mixture is about 3:2 and the lithium phosphate species is a product of heating at about 375° C.

In some embodiments, the lithium phosphate species is a reaction product of LiOEt and a phosphorus precursor wherein the molar ratio of Li:P in the reaction mixture is about 2:3 and the lithium phosphate species is a product of heating at about 150° C. In some embodiments, the lithium phosphate species is a reaction product of LiOEt and a phosphorus precursor wherein the molar ratio of Li:P in the reaction mixture is about 2:3 and the lithium phosphate species is a product of heating at about 250° C. In some embodiments, the lithium phosphate species is a reaction product of LiOEt and a phosphorus precursor wherein the molar ratio of Li:P in the reaction mixture is about 2:3 and the lithium phosphate species is a product of heating at about 300° C. In some embodiments, the lithium phosphate species is a reaction product of LiOEt and a phosphorus precursor wherein the molar ratio of Li:P in the reaction mixture is about 2:3 and the lithium phosphate species is a product of heating at about 350° C. In some embodiments, the lithium phosphate species is a reaction product of LiOEt and a phosphorus precursor wherein the molar ratio of Li:P in the reaction mixture is about 2:3 and the lithium phosphate species is a product of heating at about 375° C.

In some embodiments, the lithium phosphate species is a reaction product of LiOEt and a phosphorus precursor wherein the molar ratio of Li:P in the reaction mixture is about 1:3 and the lithium phosphate species is a product of heating at about 150° C. In some embodiments, the lithium phosphate species is a reaction product of LiOEt and a phosphorus precursor wherein the molar ratio of Li:P in the reaction mixture is about 1:3 and the lithium phosphate species is a product of heating at about 250° C. In some embodiments, the lithium phosphate species is a reaction product of LiOEt and a phosphorus precursor wherein the molar ratio of Li:P in the reaction mixture is about 1:3 and the lithium phosphate species is a product of heating at about 300° C. In some embodiments, the lithium phosphate species is a reaction product of LiOEt and a phosphorus precursor wherein the molar ratio of Li:P in the reaction mixture is about 1:3 and the lithium phosphate species is a product of heating at about 350° C. In some embodiments, the lithium phosphate species is a reaction product of LiOEt and a phosphorus precursor wherein the molar ratio of Li:P in the reaction mixture is about 1:3 and the lithium phosphate species is a product of heating at about 375° C.

In some embodiments, the lithium phosphate species is a reaction product of 0.0074 mol of LiOEt and 0.0025 mol of a phosphorus precursor. In some embodiments, the lithium phosphate species is a reaction product of 0.0147 mol of LiOEt and 0.0049 mol of a phosphorus precursor. In some embodiments, the lithium phosphate species is a reaction product of 0.0294 mol of LiOEt and 0.0980 mol of a phosphorus precursor.

Additionally, the coated active materials can be formed using any suitable method for the formation of a coating on an active materials. Common techniques for the preparation of coated active materials include, but are not limited to, a wet process wherein a rotary evaporator is used to remove a solvent from a coating solution which includes active material particles; spray drying wherein a solution of coating precursors and active material is atomized through a spray nozzle by a flow of compressed gas and the resulting aerosol is dried; dry coating wherein solid powders of the coating precursors are combined with active materials to form a combination of the two; mechano fusion mixer in which high energy milling is used to coat an active material with a coating; and, atomic layer deposition (ALD), a vapor phase coating deposition technique; or a fluidized bed reactor. Other techniques for forming coated active materials include sputter deposition and laser ablation.

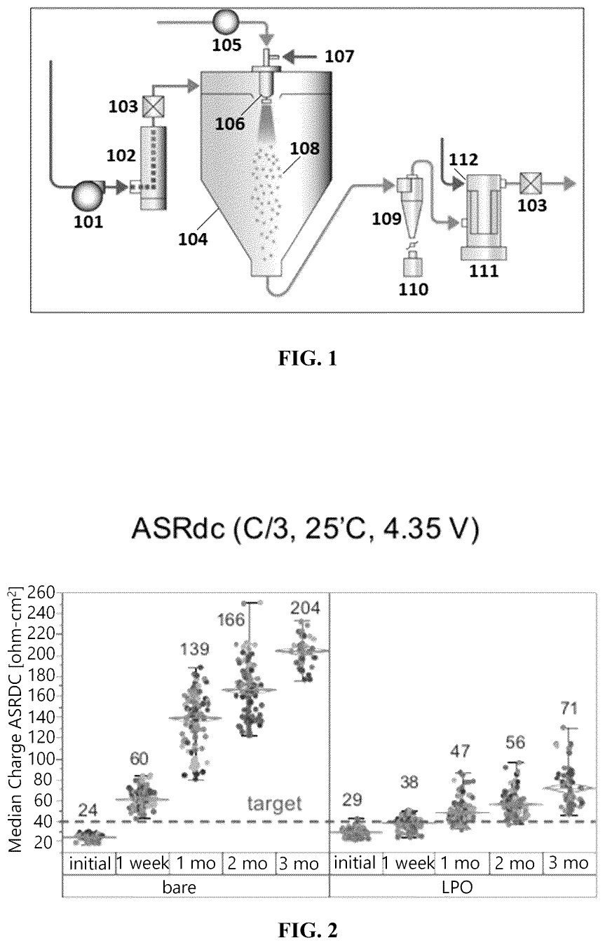

For example, one way to coat active materials is shown in FIG. 1. As shown in FIG. 1, a fan 101 is used to process air through a heater 102 and a HEPA filter 103. This processed air enters a drying chamber 104. The drying chamber is also connected to a feed pump 105. A liquid solution comprising active material and coating precursors is pumped through the feed pump 105 to the drying chamber 104 where it is atomized through a spray nozzle 106 using a carrier gas that is pumped into the drying chamber through inlet 107. The resulting droplets 108 are dried in the drying chamber 104. The dried material then passes into a cyclone 109 where the coated active materials are collected in vessel 110. The dry powder product is filtered through a Fines filter 111. In some examples, air pulses are used via input 112. The air is filtered through a second HEPA filter 103.

### Non-Limiting Embodiments

The present disclosure provides at least the following non-limiting embodiments:
(a) A composition comprising:
   cathode active material particles; and
   a coating in contact with the cathode active material particles wherein the coating comprises a lithium phosphate species and wherein at least about 60% of the surface area of the cathode active material particles is in contact with the coating as determined by TEM analysis;
(b) A composition comprising:
   cathode active material particles; and
   a coating in contact with the cathode active material particles wherein the coating comprises a lithium phosphate species and wherein the lithium phosphate species is a reaction product of a lithium precursor and a phosphorus precursor wherein the molar ratio of Li:P in the reaction mixture is about 3:1 to 1:3 and wherein the lithium phosphate species is a product of heating at a temperature from about 250° C. to 375° C.;
(c) The composition of (a), wherein at least about 65% of the surface area of the cathode active material particles is in contact with the coating;
(d) The composition of (a), wherein at least about 70% of the surface area of the cathode active material particles is in contact with the coating;
(e) The composition of (a), wherein at least about 75% of the surface area of the cathode active material particles is in contact with the coating;
(f) The composition of (a), wherein at least about 80% of the surface area of the cathode active material particles is in contact with the coating;
(g) The composition of (a), wherein at least about 85% of the surface area of the cathode active material particles is in contact with the coating;
(h) The composition of (a), wherein at least about 90% of the surface area of the cathode active material particles is in contact with the coating;
(i) The composition of (a), wherein at least about 95% of the surface area of the cathode active material particles is in contact with the coating;
(j) The composition of (a), wherein greater than about 95% of the surface area of the cathode active material particles is in contact with the coating;
(k) The composition of (a), wherein at least about 60% to 70% of the surface area of the cathode active material particles is in contact with the coating;
(l) The composition of (a), wherein at least about 70% to 80% of the surface area of the cathode active material particles is in contact with the coating;
(m) The composition of (a), wherein at least about 80% to 90% of the surface area of the active material particles cathode is in contact with the coating;
(n) The composition of (a), wherein at least about 90% to 95% of the surface area of the active material particles cathode is in contact with the coating;
(o) The composition of any one of embodiments (a)-(n), wherein the coating is amorphous.
(p) The composition of any one of embodiments (a)-(o), wherein the coating is crystalline.
(q) The composition of any one of embodiments (b) and (o)-(p), wherein the molar ratio of Li:P in the reaction mixture is about 3:1;
(r) The composition of any one of embodiments (b) and (o)-(p), wherein the molar ratio of Li:P in the reaction mixture is about 3:2;
(s) The composition of any one of embodiments (b) and (o)-(p), wherein the molar ratio of Li:P in the reaction mixture is about 1:3;
(t) The composition of any one of embodiments (b) and (o)-(p), wherein the molar ratio of Li:P in the reaction mixture is about 3:2;
(u) The composition of any one of embodiments (b) and (o)-(p), wherein the heating is from about 250° C. to 300° C.;
(v) The composition of any one of embodiments (b) and (o)-(u), wherein the heating is from about 300° C. to 350° C.;
(w) The composition of any one of embodiments (b) and (o)-(u), wherein the heating is from about 350° C. to 375° C.;
(x) The composition of any one of embodiments (b) and (o)-(u), wherein the heating is about 250° C.;
(y) The composition of any one of embodiments (b) and (o)-(u), wherein the heating is about 300° C.;
(z) The composition of any one of embodiments (b) and (o)-(u), wherein the heating is about 375° C.;
(aa) The composition of any one of embodiment (b), (o)-(z), wherein the phosphorus precursor is selected from P₂O₅, H₃PO₄, (NH₄)₃PO₄, and combinations thereof.
(bb) The composition of embodiment (aa), wherein the phosphorus precursor is P₂O₅.
(cc) The composition of embodiment (b), (o)-(z), wherein the lithium precursor is selected from LiOH, LiOEt, LiOMe, metallic lithium, and combinations thereof.
(dd) The composition of embodiment (cc), wherein the lithium precursor is LiOEt.
(ee) The composition of any one of embodiment (a)-(dd), wherein the coating is lattice-matched with the cathode active material particles.
(ff) The composition of embodiment (ee), wherein the coating has a surface which is amorphous.
(gg) The composition of embodiment (ee) or (ff), wherein the coating has a surface which is crystalline.
(hh) The composition of any one of embodiments (a)-(gg), wherein the cathode active material of the particles is selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1.
(ii) The composition of any one of embodiments (a)-(hh), wherein the cathode active material of the particles is LiNiₓMn_{y}Co_{z}O₂, x+y+z=1, 0≤x≤1, 0≤y≤1, and 0≤z≤1 and wherein x+y+z=1.
(jj) The composition of embodiment (ii), wherein the cathode active material is LiNiₓMn_{y}Co_{z}O₂, x is 0.8, y is 0.1, and z is 0.1.
(kk) The composition of embodiment (ii), wherein the cathode active material is LiNiₓMn_{y}Co_{z}O₂, x is 0.6, y is 0.2, and z is 0.2.
(ll) The composition of embodiment (ii), wherein the cathode active material is LiNiₓMn_{y}Co_{z}O₂, x is 0.5, y is 0.3, and z is 0.2.
(mm) The composition of embodiment (ii), wherein the cathode active material is LiNiₓMn_{y}Co_{z}O₂, x is 1/3, y is 1/3, and z is 1/3.
(nn) The composition of embodiment (ii), wherein the cathode active material is LiNiₓMn_{y}Co_{z}O₂, x+y+z=1, 0.80≤x≤0.97, 0≤y≤0.2, and 0≤z≤0.2.
(oo) The composition of embodiment (ii), wherein the cathode active material is LiNiₓMn_{y}Co_{z}O₂, x+y+z=1, 0.80≤x≤0.90, 0≤y≤0.2, and 0≤z≤0.2.
(pp) The composition of embodiment (ii), wherein the cathode active material is LiNiₓMn_{y}Co_{z}O₂, x+y+z=1, 0.80≤x≤0.85, 0≤y≤0.2, and 0≤z≤0.2.
(qq) The composition of embodiment (ii), wherein the cathode active material is LiNiₓMn_{y}Co_{z}O₂, x+y+z=1, 0.80≤x≤0.83, 0≤y≤0.2, and 0≤z≤0.2.
(rr) The composition of embodiment (ii), wherein the cathode active material is Li(NiCoMn)O₂.
(ss) The composition of any one of embodiments (a)-(ii), wherein the cathode active material is selected from a member from the NMC class of cathode active materials; LFP class of cathode active materials; LNMO class of cathode active materials; NCA class of cathode active materials; LMO class of cathode active materials; LCO class of cathode active materials.
(tt) The composition of any one of embodiments (a)-(ss), wherein the coating is continuous.
(uu) The composition of any one of embodiments (a)-(ss), wherein the coating is discontinuous.
(vv) The composition of any one of embodiments (a)-(uu), wherein the coating comprises crystalline domains as determined by TEM analysis.
(ww) The composition of any one of embodiments (a)-(vv), wherein the coating comprises amorphous domains as determined by TEM analysis.
(xx) The composition of any one of embodiments (a)-(ww), wherein the coating comprises crystalline domains and amorphous domains as determined by TEM analysis.
(yy) The composition of embodiment (xx), wherein the crystalline domains are in contact with the cathode and the amorphous domains are in contact with the crystalline domains.
(zz) The composition of any one of embodiments (a)-(xx), wherein the coating has a thickness, T, as determined by TEM analysis, that is 1 nm≤T≤20 nm.
(aaa) The composition of any one of embodiments (a)-(xx), wherein the coating has a thickness, T, as determined by TEM analysis, that is 1 nm≤T≤10 nm.
(bbb) The composition of any one of embodiments (a)-(xx), wherein the coating has a thickness, T, as determined by TEM analysis, that is 1 nm≤T≤3 nm.
(ccc) The composition of any one of embodiments (a)-(xx), wherein the coating has a thickness, T, as determined by TEM analysis, that is less than 1 nm.
(ddd) The composition of any one of embodiments (a)-(xx), wherein the coating is not thicker than the TEM can detect.
(eee) The composition of any one of embodiments (a)-(ddd), wherein the coating crystalline domains lattice match the crystalline domains of the cathode active material, as determined by TEM analysis.
(fff) The composition of any one of embodiments (a)-(ddd), wherein the coating crystalline domains do not lattice match the crystalline domains of the cathode active material, as determined by TEM analysis.
(ggg) The composition of any one of embodiments (a)-(fff), wherein the coating further comprises carbonate.
(hhh) The composition of any one of embodiments (a)-(ggg), further comprising a second coating in contact with the coating.
(iii) The composition of embodiment (hh), wherein the second coating has a chemical formula which is not Li₃PO₄.
(jjj) The composition of embodiment (iii), wherein the second coating has the chemical formula:
   LiₓZr_{y}O_{z}, wherein 0≤x≤1.6, 0.2≤y≤1.0, and 2≤z≤1.2;
   LiₓP_{y}O_{z}, wherein 0.6≤x≤1.5, 0.5≤y≤1.4, and 2.0≤z≤3.7;
   LiₓZr_{y}(PO₄)_{z}, wherein 0.05≤x≤1.5, 1≤y≤3, and 2.0≤z≤4.0;
   LiₓC_{y}O_{z}, wherein 0.4≤x≤1.8, 0.1≤y≤1, and 1≤z≤1.8;
   LiₓB_{y}O_{z}, wherein 0.2≤x≤0.75, 0.5≤y≤1.6, and 1.5≤z≤2.6;
   LiₓIn_{y}Cl_{z}, wherein 2≤x≤4, 0≤y≤2, and 5≤z≤7;
   LiₓZr_{y}(PO₄)_{z}, wherein 0.05≤x≤1.5, 1≤y≤3, and 2.0≤z≤4.0;
   Li₂CO₃; Li₃BO₃; Li₃B₁₁O₁₈; Li₂ZrO₃; Li₃PO₄; Li₂SO₄; LiNbO₃; Li₄Ti₅O₁₂; LiₓTi₂(PO₄)₃;
   LiZr₂(PO₄)₃; LiOH; LiF; Li₄ZrF₈; Li₃Zr₄F₁₉; Li₃TiF₆; LiAlF₄; LiYF₄; LiNbF₆; ZrO₂;
   Al₂O₃; TiO₂; ZrF₄; AlF₃; TiF₄; YF₃; NbF₅; and combinations thereof.
(kkk) A process for making a composition of any one of embodiments (a)-(ggg); comprising the following steps: 1) coating cathode active material particles with a solution of a) a lithium precursor and b) a phosphorus precursor wherein the molar ratio of Li:P in the reaction mixture is about 3:1 to 1:3; 2) removing the solvent from the solution to provide a lithium phosphate species-coated cathode; and, 3) heating the cathode active material under dry air conditions at a temperature from about 250° C. to 375° C. to form lithium phosphate species-coated cathode active material particles;
(lll) The process of embodiment (kkk), wherein the phosphorus precursor is P₂O₅;
(mmm) The process of embodiment (kkk) or (lll), wherein the heating is at a temperature of about 375° C.; and
(nnn) The process ofembodiment (kkk) or (lll), wherein the heatingis at atemperature of about 250° C.

### EXAMPLES

Reagents, chemicals, and materials were commercially purchased unless specified otherwise to the contrary.

The Lithium Nickel Cobalt Manganese Oxide (NMC) used in the Examples was LiNi_{0.84}Co_{0.09}Mn_{0.07}O₂, LiNi_{0.88}Co_{0.11}Mn_{0.01}O₂, or LiNi_{0.89}Co_{0.8}Mn_{0.03}O₂ unless specified otherwise.

### Example 1: Preparation of Coated Nmc

Sixteen NMC cathode active materials with lithium phosphate species attached thereto were prepared by the process described below. The starting material elemental molar ratio, the amount of starting material, and heating temperature for each cathode is described in Table 1.

TABLE 1
Starting Material and Molar Ratio
Lithium Phosphate Species Coatings

| | | LiOEt (as LiOEt | | P₂O₅ (as P₂O₅ | | | |
|---|---|---|---|---|---|---|---|
| | | stock solution per | | stock solution per | | Heating | |
| Cath- | | 100 g cathode | | 100 g cathode | | temperature | |
| ode | Li:P | active material) | | active material) | | (O₂) | |
| 1 | 3:2 | 0.0147 | mol | 0.0049 | mol | 250° | C. |
| 2 | 3:2 | 0.0147 | mol | 0.0049 | mol | 150° | C. |
| 3 | 3:2 | 0.0147 | mol | 0.0049 | mol | 375° | C. |
| 4 | 3:2 | 0.0074 | mol | 0.0025 | mol | 250° | C. |
| 5 | 3:2 | 0.0074 | mol | 0.0025 | mol | 150° | C. |
| 6 | 3:2 | 0.0294 | mol | 0.0980 | mol | 250° | C. |
| 7 | 3:1 | 0.0147 | mol | 0.0025 | mol | 375° | C. |
| 8 | 3:1 | 0.0147 | mol | 0.0025 | mol | 250° | C. |
| 9 | 3:1 | 0.0147 | mol | 0.0025 | mol | 150° | C. |
| 10 | 3:1 | 0.0147 | mol | 0.0025 | mol | 500° | C. |
| 11 | 3:1 | 0.0147 | mol | 0.0025 | mol | 650° | C. |
| 12 | 3:1.5 | 0.0147 | mol | 0.0038 | mol | 250° | C. |
| 13 | 3:1.5 | 0.0147 | mol | 0.0038 | mol | 300° | C. |
| 14 | 3:1.5 | 0.0147 | mol | 0.0038 | mol | 375° | C. |
| 15 | 3:0.01 | 0.0147 | mol | 0.00025 | mol | 250° | C. |
| 16 | 3:3 | 0.0147 | mol | 0.0075 | mol | 250° | C. |

### Coating Procedure 1

### Step 1:

A solution was prepared by mixing LiOEt and P₂O₅ stock solutions in ethanol (Sigma) at 25° C. in an argon filled glovebox (H₂O≤0.1 ppm, O₂<0.1 ppm).

### Step 2: Coating Step

Lithium Nickel Cobalt Manganese Oxide (NMC) powder was put into the solution prepared in step 1 and stirred for 1.5 hours. After stirring, the powder was dried using a rotary evaporator at 65° C. to remove the solvent.

### Step 3: Heating Step

The powder obtained from step 2 was heated under an O₂ atmosphere at the temperature in Table 1 for 1 hour. This resulted in the coated cathode material. Coated cathodes were stored under dry atmosphere (dp<−50° C.).

### Coating Procedure 2

### Step 1:

A solution was prepared by mixing Lithium Nickel Cobalt Manganese Oxide (NMC) powder in ethanol (Sigma) at 25° C. in an argon filled glovebox (H₂O≤0.1 ppm, O₂<0.1 ppm).

### Step 2: Coating Step

Separately, two solutions were prepared by mixing a LiOEt stock solution in ethanol and a P₂O₅ stock solution in ethanol at 25° C. in an argon filled glovebox (H₂O≤0.1 ppm, O₂<0.1 ppm). The LiOEt solution was added dropwise to the NMC solution in step 1 over the span of 5-10 minutes. After the complete addition of LiOEt, the P₂O₅ solution was added dropwise to the NMC solution in step 1 over the span of 5-90 minutes. The resulting solution was stirred for 1.5 hours. After stirring, the powder was dried using a rotary evaporator at 65° C. to remove the solvent.

### Step 3: Heating Step

The powder obtained from step 2 was heated under an O₂ atmosphere at the temperature in Table 1 for 1 hour. This resulted in the coated cathode material. Coated cathodes were stored under dry atmosphere (dp<−50° C.).

### Example 2: Area-Specific Resistance (ASR) Testing

A cathode electrode was prepared by mixing 2% Super C65, 2% Kynar® HSV, and 96% by weight of NMC in NMP (n-methyl pyrrolidone). After mixing and degassing, the slurry was cast onto an aluminum foil with a doctor blade to a thickness that achieves 28 mg/cm² of dry material. The electrode was dried of NMP at 120° C. for eight hours. The electrode was calendered to a thickness where the porosity was 25% or 35% by volume as determined by scanning electron microscopy. Cathode electrode discs of 8 mm diameter were punched from the cathode electrode sheet.

Cells were constructed using a lithium-stuffed garnet separator, lithium-free lithium metal anode, and the cathode electrode described above. Lithium-free means the cells were assembled in a discharged state. Before cell assembly, the cathode electrode was soaked in a catholyte mixture of ESS (70:30 v/v % ethylene sulfite:sulfolane+1.4M LiBF₄ or 85:15 v/v % ethylene sulfite:sulfolane+1.7M LiBF₄:LiTFSI (80:20)). After soaking, excess electrolyte was removed by dabbing, and then 0.5-3 μL of excess electrolyte was added to the cathode-separator interface with a pipette. An anode current collector foil with a tab was placed in contact with the anode side of the separator and a cathode current collector foil with a tab was placed in contact with the Al foil on the back of the cathode electrode. A pouch was sealed around the cell, with the tabs sticking out of the cell to make electrical connections to each electrode.

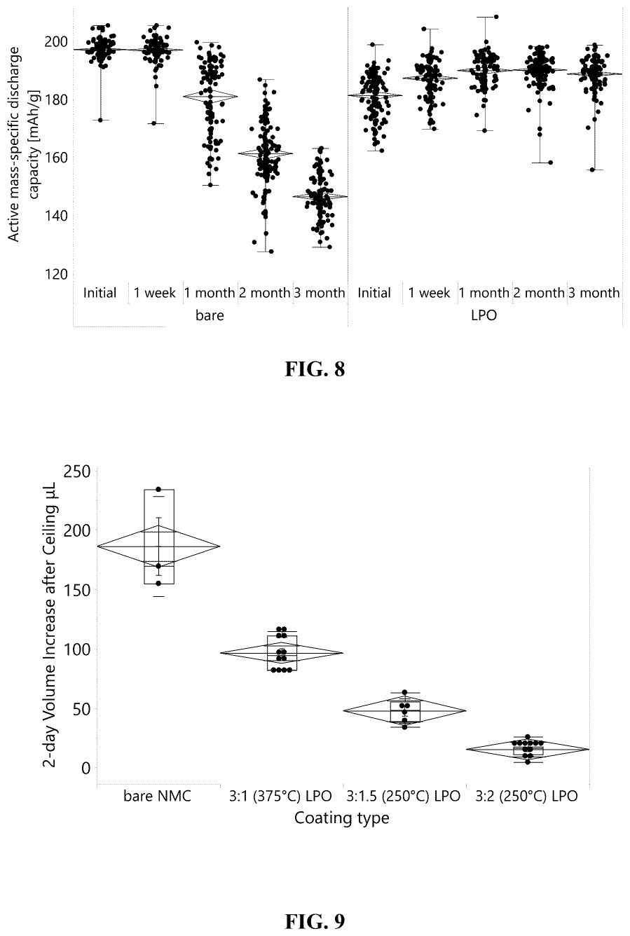

The results are shown in FIG. 2. The lithium phosphate species coating significantly improved ASR growth up to 3 months post-HTHV. Further, the capacity grew in and did not decrease up to 3 months HTHV, as shown in FIG. 8.

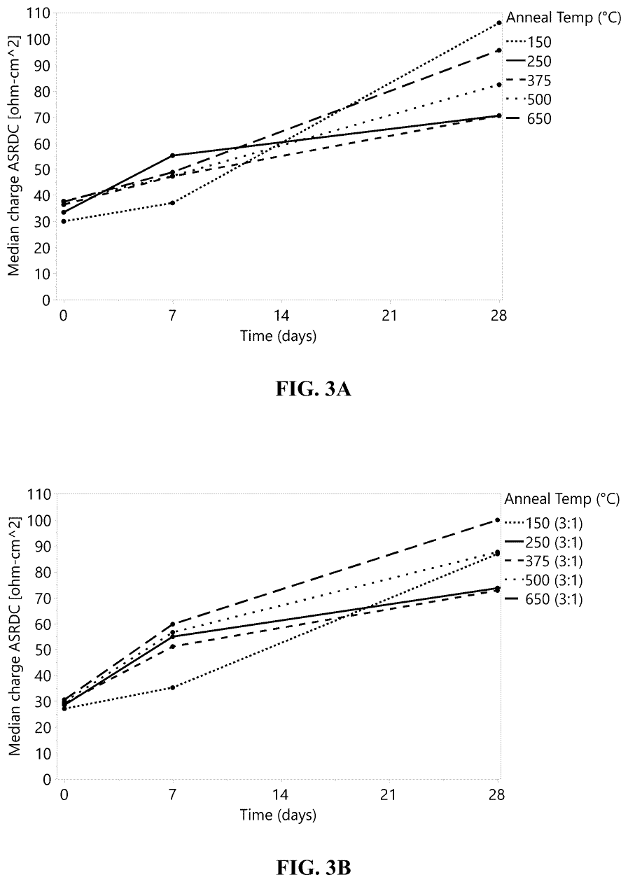

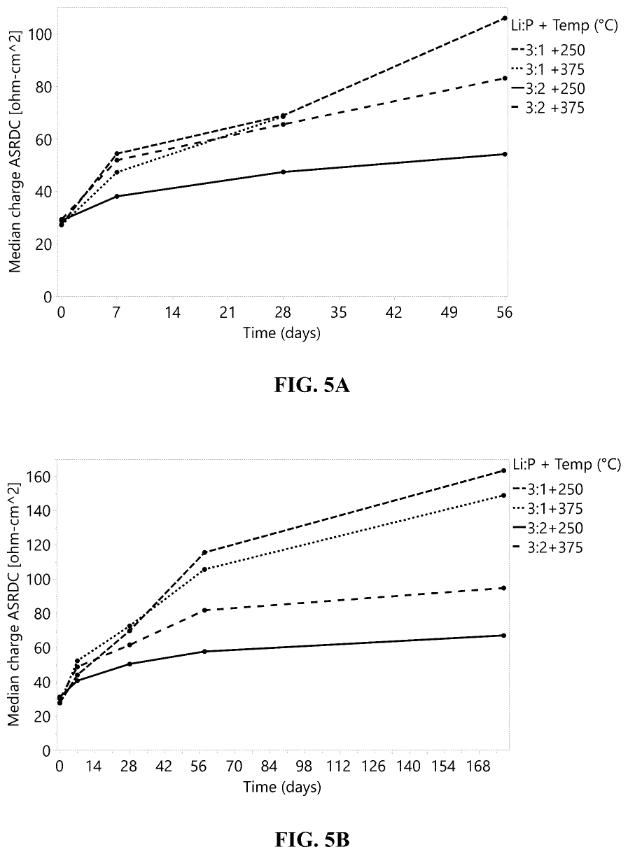

Each data point in FIGS. 3A-3B, 4A-4B, 5A-5B, 6A-6B, and 7A-7B represents an average of a number of experiments, wherein the subsequent figure in each set contains averages of a larger number of experiments, and for FIGS. 5B, 6B and 7B, data at longer time points.

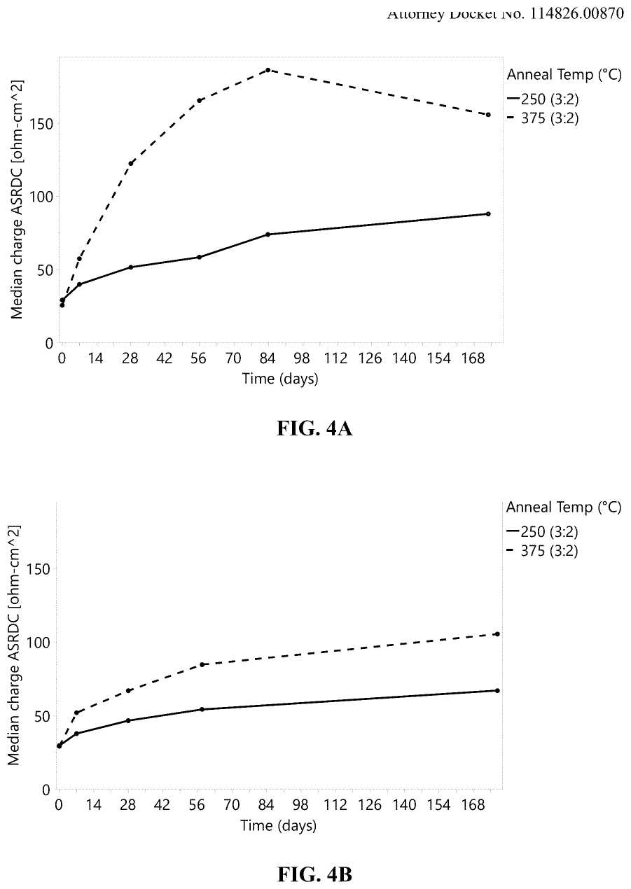

Additional ASR testing was conducted to study the effect of the heating temperature of the cathode, the ratio of Li to P starting material in the coating, and the amount of starting material in the coating. The effect of heating temperature is shown in FIG. 3A-3B and FIG. 4A-4B. The median change was measured over the course of 28 days for battery cells made with cathodes heated at 150° C., 250° C., 375° C., 500° C., and 650° C. and made with a starting ratio of Li to P of 3:2 (Cathodes 1 and 3 from Table 1) and a ratio of Li to P of 3:1 (Cathodes 7-10 from Table 1). As shown in FIGS. 3A-3B, after 28 days, battery cells made from cathodes heated at 250° C. and 375° C. and a starting ratio of Li to P of 3:1 exhibited the lowest median change. The median change was comparable between the two temperatures. Each data point represents an average of at least 30 experiments in FIG. 3A and at least 60 experiments in FIG. 3B. FIGS. 4A-4B shows the change in ASR over the course of 175 days for cathodes heated at 250° C. and 375° C. and a starting ratio of Li to P of 3:2. Each data point represents an average of at least 5 experiments in FIG. 4A and at least 50 experiments in FIG. 4B. As shown in FIGS. 4A-4B, after 175 days, the battery cell made from a cathode heated at 250° C. surprisingly exhibited a smaller change in ASR than the battery cell made from a cathode heated at 375° C.

To study the effect of the Li to P starting material ratio, battery cells were made with Cathodes 1, 3, 7, and 8 from Table 1 were tested and the results are shown in FIGS. 5A-5B. Each data point represents an average of at least 5 experiments in FIG. 5A and at least 40 experiments in FIG. 5B. In addition, FIG. 5B includes ASR testing up to 178 days. The battery cells made from cathodes coated with a 3:2 Li:P ratio exhibited lower ASR changes than the battery cells made with cathodes coated with a 3:1 Li:P ratio regardless of the heating temperature. Of the two cathodes coated with a 3:2 Li:P ratio, the cathode heated at 250° C. resulted in the lower change in ASR than the cathode heated at 375° C.

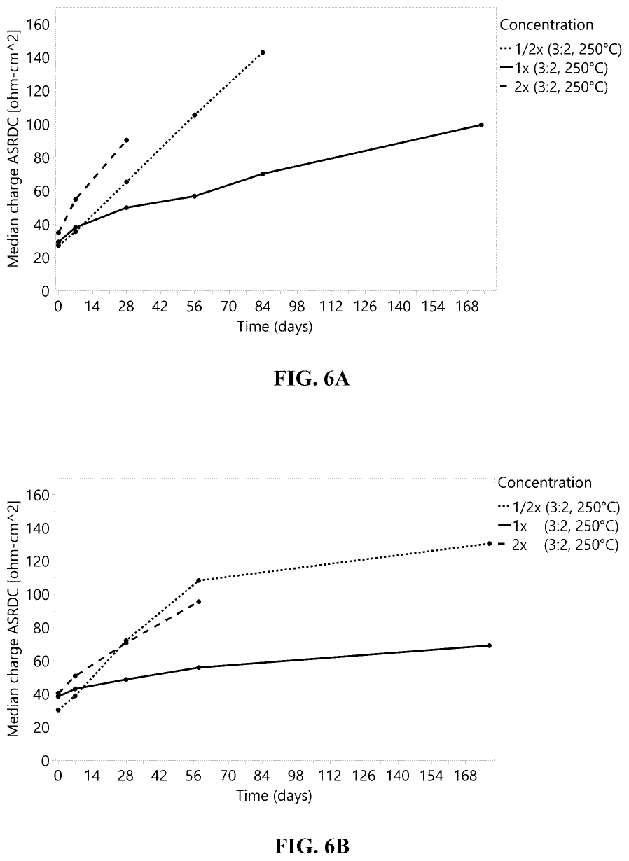

To study the effect of the amount of starting material, three cathodes coated with varying amounts of LiOEt and P₂O₅, but in a Li:P ratio of 3:2, were prepared and heated at 250° C. Battery cells made from Cathodes 1, 4, and 6 were prepared and tested and the results are shown in FIGS. 6A-6B. Each data point represents an average of at least 5 experiments in FIG. 6A and at least 20 experiments in FIG. 6B. In addition, FIG. 6B includes ASR testing up to 178 days. Of the three cathodes, Cathode 1 resulted in the smallest change to ASR from initial.

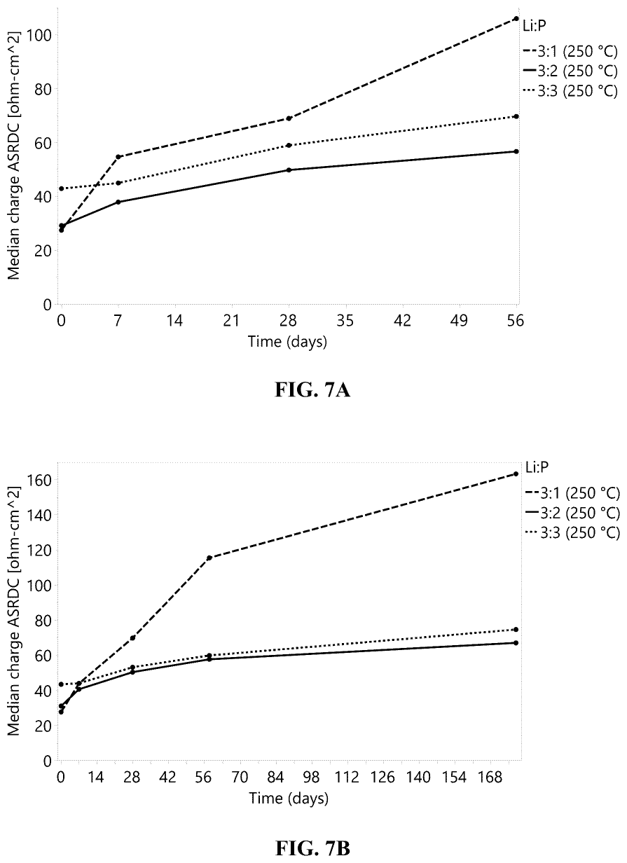

Lastly, battery cells made from Cathodes 1 and 8 were compared to a battery cell made from a cathode prepared with LiOEt and P₂O₅ wherein the ratio of Li:P was 3:3 and heated at a temperature of 250° C. (Cathode 16), as shown in FIGS. 7A-7B. Each data point represents an average of at least 5 experiments in FIG. 7A and at least 40 experiments in FIG. 6B. In addition, FIG. 6B includes ASR testing up to 178 days. The battery cell made from Cathode 1 (ratio of Li:P of 3:2) performed the best.

These studies show that small changes to the starting material amounts and ratio can impact ASR. It could not have been predicted that Cathode 1 would outperform the other cathodes of Table 1 made from starting materials in a Li:P ratio of 3:2. It also could not have been predicted that changing the Li:P ratio to 3:1 or 3:3 would be detrimental to ASR.

### Example 3: Gas Evolution Testing

Cells comprising cathodes from Table 1 were prepared as in Example 1 and 2. The cells were attached to a strain gauge and submerged in a solution of potassium formate and water. The cells were held at a voltage of 4.25V for 2 days. The gas evolution of the cell was measured as a difference between the overall measured volume change and the volume change as a result of the lithium plating.

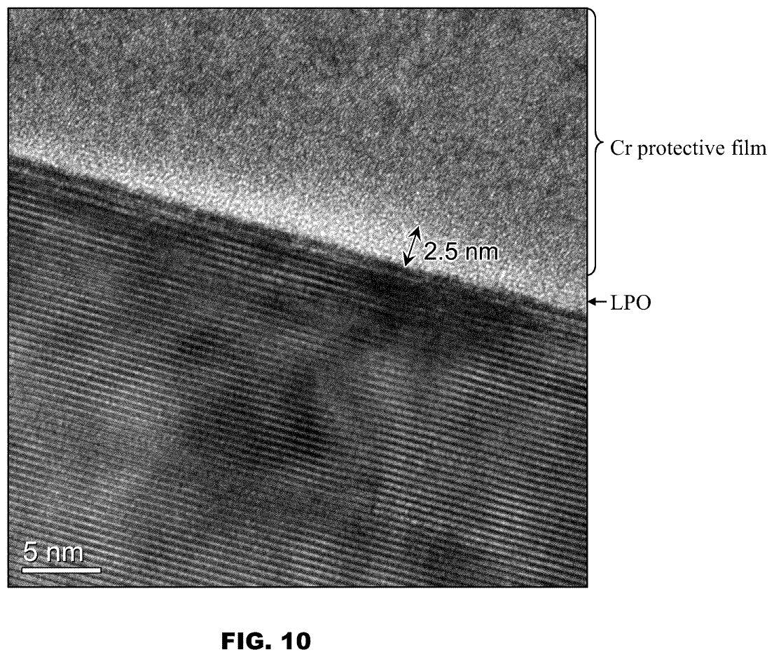

The results are shown in FIG. 9. Compared to cells made with uncoated cathodes, cells with cathodes coated with lithium phosphate species (Cathode 1, 7, and 12) resulted in a reduction of gas evolution after two days. Furthermore, battery cells made with cathodes coated with a starting material ratio of Li:P of 3:2 and heated at a temperature of 250° C. (Cathode 1) yielded less gas after two days than cathodes coated with a Li:P ratio of 3:1.5 and heated at 250° C. (Cathode 12) as well as a Li:P ratio of 3:1 heated at 375° C. (Cathode 7).

### Example 4: TEM (Transmission Electron Microscopy) Analysis

An NMC coated with lithium phosphate species was prepared for TEM measurements using Ga ion sourced focused ion beam (nanoDUE'T NB5000, Hitachi High-Technologies). To protect the surface of material from the Ga ion beam, multiple protective layers were deposited in advance to the sampling; at first, metal layer was deposited by plasma coater and then carbon protective layer and tungsten layer were deposited by high vacuum evaporation and focused ion beam, respectively. The thin slice sampling was conducted by focused ion beam. The prepared sample was measured in TEM.

TEM images of NMC coated with lithium phosphate species were obtained by field emission electron microscope (JEM-2100F, JEOL). The Acceleration voltage was set to 200 kV. The electron beam radius was set to about 0.7 to 1 nm.

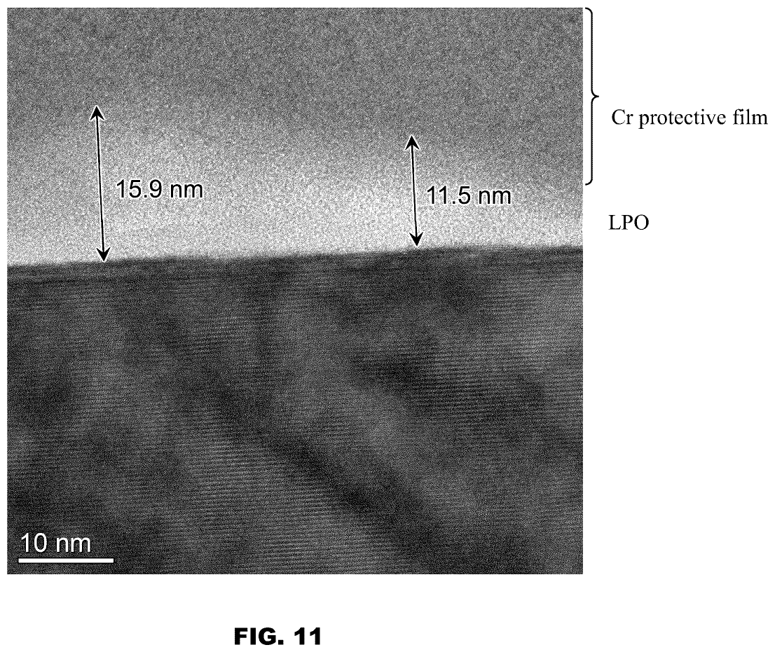

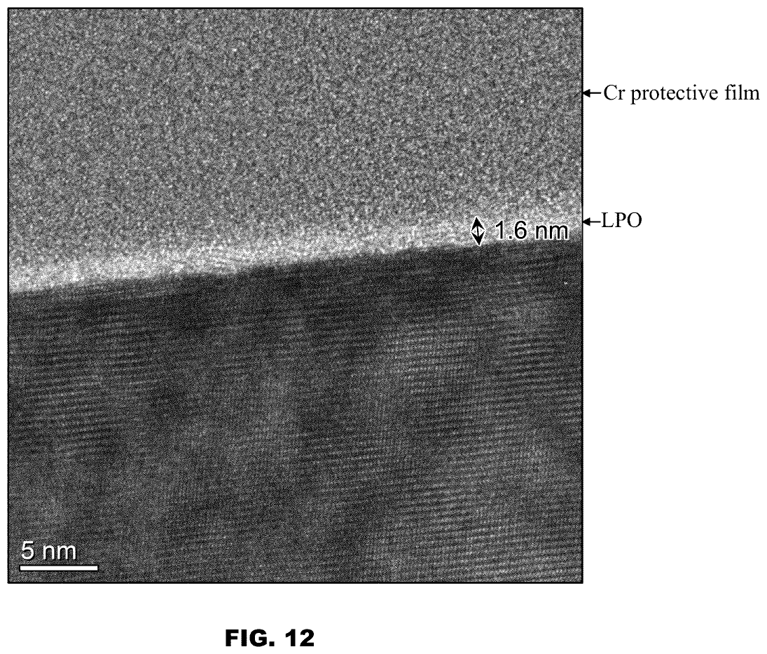

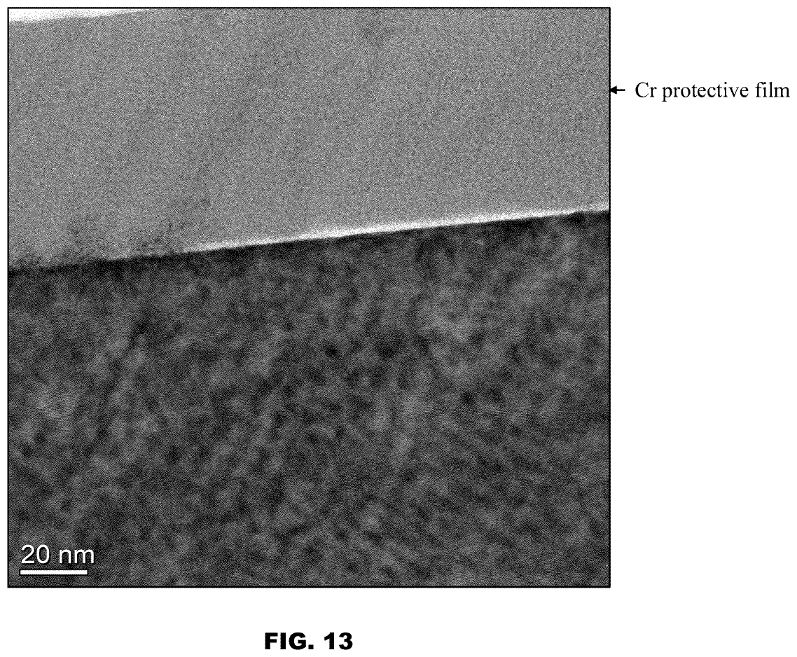

FIGS. 10-11 are different particles of the same sample wherein the coating has a Li:P ratio of 3:2 and heated at 250° C., and the coating in FIGS. 12-13 has a Li:P ratio of 3:1 and heated at 375° C.

In FIG. 10, the coating has a thickness of about 2.5 nm, while in FIG. 11, the coating has thickness of between 11.5 and 15.9 nm. In both images, the lithium phosphate species coating is amorphous.

FIG. 12 is a TEM image of lithium phosphate species-coated NMC heated at 375° C. where the lithium phosphate species coating is crystalline.

FIG. 13 is a TEM image of lithium phosphate species-coated NMC where the coating is discontinuous.

### Example 5: XPS (X-Ray Photoelectron Spectroscopy) Analysis

NMCs with coatings 1, 7, 8, 10, 12, 13 and 14 were transferred to the XPS system (ThermoFisher Scientific K-Alpha) under dry atmosphere (−50° C.). XPS analysis was performed with Monochromated, Micro-focused Al-Ka as X-ray source at a pressure of 10-8 Torr. The diameter of the analyzed area was 400 mm.

The XPS spectra were fitted using Gaussian/Laurentzian product function peak shape model in combination with background. For peak fitting Smart-type background subtraction was used. Quantification has been done using sensitivity factors provided by Avantage library. The results are shown in Table 2. Zirconium (Zr) is present as a dopant in the NMC cores.

TABLE 2
XPS ANALYSIS (P/Zr)

| | | Heating | | | | |
|---|---|---|---|---|---|---|
| | | Temp | Coating | P/Zr | P/Zr | P/Zr |
| Coating | Li:P | (° C.) | Procedure | min | ave | max |
| 1 | 3:2 | 250 | 1 | 52.107 | 81.953 | 121.882 |
| 12 | 3:1.5 | 250 | 1 | 53.818 | 68.422 | 95.769 |
| 13 | 3:1.5 | 300 | 1 | — | 32.883 | — |
| 14 | 3:1.5 | 375 | 1 | — | 40.763 | — |
| 8 | 3:1 | 250 | spray | — | 30.570 | — |
| | 3:1 | 275 | 1 | — | 29.657 | — |
| 7 | 3:1 | 375 | 1 | 21.770 | 23.728 | 25.876 |
| 7 | 3:1 | 375 | 2 | 5.328 | 17.693 | 27.509 |
| 10 | 3:1 | 500 | 1 | — | 19.524 | — |

TABLE 2
XPS ANALYSIS (CO₃/Zr)

| | | Heating | | | | |
|---|---|---|---|---|---|---|
| | | Temp | Coating | CO₃/ | CO₃/ | CO₃/ |
| Coating | Li:P | (° C.) | Procedure | Zr min | Zr ave | Zr max |
| 1 | 3:2 | 250 | 1 | 9.182 | 11.872 | 13.965 |
| 12 | 3:1.5 | 250 | 1 | 18.007 | 21.749 | 25.097 |
| 13 | 3:1.5 | 300 | 1 | — | 22.235 | — |
| 14 | 3:1.5 | 375 | 1 | — | 19.746 | — |
| 8 | 3:1 | 250 | spray | — | 32.759 | — |
| | 3:1 | 275 | 1 | — | 24.987 | — |
| 7 | 3:1 | 375 | 1 | 21.377 | 24.084 | 25.733 |
| 7 | 3:1 | 375 | 2 | 22.930 | 33.861 | 67.903 |
| 10 | 3:1 | 500 | 1 | — | 23.925 | — |

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

1-39. (canceled)

40. A composition comprising cathode active material particles and a coating in contact with the cathode active material particles, wherein the coating comprises a lithium phosphate species comprising a compound of a formula LiₓP_{y}O_{z}, wherein 1.0≤x≤4.0, 0≤y≤2.0, and 2.0≤z≤7.0.

41. The composition of claim 40, wherein the formula is charge neutral.

42. The composition of claim 40, wherein 1.0≤x≤4.0, 0≤y≤2.0, and 2.0≤z≤7.0.

43. The composition of claim 40, wherein 1.0≤x≤1.5, 0.5≤y≤1.4, and 2.0≤z≤3.7.

44. The composition of claim 40, wherein 2.0≤x≤4, 0≤y≤2.0, and 2.0≤z≤5.0.

45. The composition of claim 40, wherein the coating comprises crystalline domains, amorphous domains, or both, as determined by TEM analysis.

46. The composition of claim 45, wherein the crystalline domains, the amorphous domains, or both, are in contact with the cathode active material particles.

47. The composition of claim 40, wherein the coating is continuous or discontinuous.

48. The composition of claim 40, wherein the coating has a thickness, T, as determined by TEM analysis, of about 1 nm≤T≤20 nm.

49. The composition of claim 40, wherein a cathode active material is selected from LiMPO₄, wherein M is selected from Fe, Ni, Co, or Mn; LiₓFe_{(1-y)}Mn_{y}PO₄, wherein 1≤x≤5 and 0≤y≤1; LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; or LiNiₓCo_{y}Al_{z}O₂, wherein x+y+z=1, and 0≤x≤1, 0≤y≤1, and 0≤z≤1.

50. The composition of claim 49, wherein the cathode active material is LiNiₓMn_{y}Co_{z}O₂, wherein x+y+z=1, and cither (a)-(d):
(a) 0.80≤x≤0.97, 0≤y≤0.2, and 0≤z≤0.2;
(b) 0.80≤x≤0.90, 0≤y≤0.2, and 0≤z≤0.2;
(c) 0.80≤x≤0.85, 0≤y≤0.2, and 0≤z≤0.2; or
(d) 0.80≤x≤0.83, 0≤y≤0.2, and 0≤z≤0.2.

51. The composition of claim 40, wherein further comprising a second coating in contact with the coating, and the second coating has the chemical formula:
LiₓZr_{y}O_{z}, wherein 0≤x≤1.6, 0.2≤y≤1.0, and 2≤z≤1.2;
LiₓP_{y}O_{z}, wherein 0.6≤x≤1.5, 0.5≤y≤1.4, and 2.0≤z≤3.7;
LiₓZr_{y}(PO₄)_{z}, wherein 0.05≤x≤1.5, 1≤y≤3, and 2.0≤z≤4.0;
LiₓC_{y}O_{z}, wherein 0.4≤x≤1.8, 0.1≤y≤1, and 1≤z≤1.8;
LiₓB_{y}O_{z}, wherein 0.2≤x≤0.75, 0.5≤y≤1.6, and 1.5≤z≤2.6;
LiₓIn_{y}Cl_{z}, wherein 2≤x≤4, 0≤y≤2, and 5≤z≤7;
LiₓZr_{y}(PO₄)_{z}, wherein 0.05≤x≤1.5, 1≤y≤3, and 2.0≤z≤4.0;
or combinations thereof.

52. The composition of claim 40, wherein the lithium phosphate species further comprises a lithium organophosphate wherein the lithium organophosphate is selected from the group consisting of lithium diethylphosphate, lithium dimethylphosphate, lithium diisopropylphosphate, lithium ethyl methyl phosphate, lithium ethyl isopropyl phosphate, lithium methyl isopropyl phosphate, dilithium methylphosphate, dilithium ethylphosphate, dilithium isopropylphosphate or combinations thereof.

53. A composition comprising cathode active material particles and a coating in contact with the cathode active material particles, wherein the coating comprises a lithium phosphate species, wherein the cathode active material particles were coated using a reaction mixture comprising a lithium precursor and a phosphorous precursor at a Li:P molar ratio of about 3:1 to 1:3 at a temperature from about 250° C. to 375° C.

54. The composition of claim 53, wherein the molar ratio of Li:P in the reaction mixture is about 3:1 to 3:3.

55. The composition of claim 53, wherein the phosphorus precursor is selected from P₂O₅, H₃PO₄, (NH₄)₃PO₄, or combinations thereof.

56. The composition of claim 53, wherein the lithium precursor is selected from lithium hydroxide (LiOH), lithium ethoxide (LiOEt), lithium methoxide (LiOMe), metallic lithium, and combinations thereof.

57. A process for making cathode active material particles coated with a lithium phosphate species, the process comprising:
1) coating cathode active material particles with a reaction mixture comprising a lithium precursor, a phosphorus precursor, and a solvent, wherein the molar ratio of Li:P in the reaction mixture is about 3:1 to 1:3;
2) removing the solvent from the reaction mixture; and
3) heating the cathode active material particles at a temperature from about 250° C. to 375° C., under dry air conditions or an 02 atmosphere, to form cathode active material particles coated with a lithium phosphate species.

58. The process of claim 57, comprising heating the cathode active material particles to about 350° C. to 375° C.

59. The process of claim 57, comprising heating the cathode active material particles to about 300° C. to 350° C.

60. The process of claim 57, wherein the lithium phosphate species is Li₃PO₄, LiPO₃, Li₄P₂O₇, Li₄P₂O₇/Li₃PO₄, Li₄P₂O₇/LiPO₃, a lithium organophosphate, or combinations thereof
